(19) United States
(12) Patent Application Publication
(10) Pub. No.: US 2023/0305207 A1
(43) Pub. Date: Sep. 28, 2023

(54) HEAD-UP DISPLAY SYSTEM WITH HALF WAVEPLATE OPTIMIZED FOR BETTER PERFORMANCE

(71) Applicant: EASTMAN CHEMICAL COMPANY, KINGSPORT, TN (US)

(72) Inventors: QIANQIAN ZHANG, KINGSPORT, TN (US); BIN WANG, KINGSPORT, TN (US); STEVEN V. HALDEMAN, HAMPDEN, MA (US); CASEY LYNN ELKINS, KINGSPORT, TN (US)

(73) Assignee: EASTMAN CHEMICAL COMPANY, KINGSPORT, TN (US)

(21) Appl. No.: 18/014,571

(22) PCT Filed: Jun. 30, 2021
(86) PCT No.: PCT/US2021/039748

§ 371 Date: Jan. 5, 2023

Related U.S. Application Data
(60) Provisional application No. 63/050,939, filed on Jul. 13, 2020.

(51) Int. Cl. G02B 5/30; G02B 27/01

(52) U.S. Cl. CPC G02B 5/3016; G02B 27/0101

(57) ABSTRACT

The present application discloses interlayers comprising half waveplate (“HWP”) films and head-up display systems incorporating the interlayers. The interlayers and head-up display systems are optimized so that the optical axis has an angle phi (Φ) relative to the axis formed from the p-polarization direction of a display light projected onto the plane of the HWP film. The optimized φ depends on the optical properties of the films.

### BACKGROUND OF THE INVENTION

Laminated safety glass has been used in vehicles equipped with head-up display (“HUD”) systems, which project an image of an instrument cluster or other important information to a location on the windshield at the eye level of the vehicle operate. Such displays allow the driver to stay focused on the upcoming path of travel while visually accessing dashboard information. Generally, the HUD system in an automobile or an aircraft uses the inner surface of the vehicle windscreen to partially reflect the projected image. However, there is a secondary reflection taking place at the outside surface of the vehicle windscreen that forms a weak secondary image or “ghost” image. Since these two reflective images are offset in position, double images are often observed, which cause an undesirable viewing experience to the driver. When the image is projected onto a windshield which as a uniform and consistent thickness, the interfering double or reflective ghost image is created due to the differences in the position of the projected images as it is reflected off the inside and outside surfaces of the glass.

One method of addressing these double or ghost images is to include a coating, such as a dielectric coating, on one of the surfaces of the windshield between the glass and the interlayer in the windshield. The coating is designed to product a third ghost image at a location very close to the primary image, while significantly reducing the brightness of the secondary image, so that the secondary image appears to blend into the background. Unfortunately, at times, the effectiveness of such a coating can be limited and the coating itself may create other issues, such as it may interfere with the adhesion of the interlayer to the glass substrates, resulting in optical distortion and other issues.

Another method of reducing ghost images in windshields has been to orient the inner and outer glass panels at an angle from one another. This approach aligns the position of the reflected images to a single point, thereby creating a single image. Typically, this is done by displacing the outer panel relative to the inner panel by employing a wedge-shaped, or “tapered,” interlayer that includes at least one region of nonuniform thickness. Many conventional tapered interlayers include a constant wedge angle over the entire HUD region, although some interlayers have recently been developed that include multiple wedge angels over the HUD region.

The problem with tapered interlayers is that the wedge angle(s) required to minimize the appearance of ghost images depend on a variety of factors, including the specifics of the windshield installation, the projection system design and set up, and the position of the user, as further described below. Many tapered interlayers are designed and optimized for a single set of conditions unique to a given vehicle. Further, the set of optimization conditions usually includes an assumed driver position (or nominal drive height), including driver height, distance of the driver from the windshield, and the angle at which the driver views the projected image. While a driver of the height at which the windshield was optimized may experience little or no reflected double images or ghost images, drivers taller and shorter than the nominal driver height may experience significant ghost imaging.

Further, wedge shaped or tapered interlayers can be difficult to handle efficiently. Since the interlayer does not have a constant or uniform thickness profile (that is, a portion of the interlayer is thicker than the rest of the interlayer when producing the interlayer and winding it onto a roll, the roll is not cylindrical in shape. If the wedge is a constant wedge, the roll may be conical in shape. This makes it difficult to handle, transport and store.

Thus, a need still exists for a windshield or windscreen suitable for use in HUD systems that does not have ghost or double images and that is suitable for multiple types of vehicles and different drivers. The instant patent application discloses at least one way of reducing the ghost image by incorporating a half waveplate (“HWP”) film into the interlayer of a head-up display system whereby the optical axis of the HWP film relative to the projection of the p-polarization direction of the incident light displayed onto the plane of the HWP film makes an angle phi (Φ) wherein Φ is from an angle of 30° to less than 45°, or an angle of greater than 135° to 150°.

### SUMMARY OF THE INVENTION

The present application discloses an interlayer, comprising:
(a) a first polymer layer; and
(b) a half waveplate (“HWP”) film comprising a polymeric material,
   wherein the HWP film has a plane and an optical axis, wherein the optical axis has an angle phi (Φ) relative to the axis formed from the p-polarization direction of a display light projected onto the plane of the HWP film,
   wherein Φ is from an angle of 30° to less than 45°, an angle of greater than 45° to 55°, an angle of greater than 135° to 150°, or an angle of 125° to less than 135°, and
   wherein the HWP film exhibits an in-plane retardation measured at 550 nm (“Rₑ[550 nm]”) of from -200 nm to -350 nm or from 200 nm to 350 nm, and an out-of-plane retardation measured at 550 nm (“Rₜₕ[550 nm]”) of from -350 nm to 350 nm.
The present application also discloses head up display systems incorporating the interlayers described herein.

### BRIEF DESCRIPTION OF THE DRAWINGS

Various embodiments of the present invention are described in detail below with reference to the attached drawing Figures, wherein:

FIG. 1 shows two ways of eliminating ghost image R_{gh} in HUDs using an HWP film. FIG. 1(a) shows an example using s-polerization light and the primary image Rₚᵣ from inter surface of the windshield; and FIG. 1(b) shows incident p-polarization light and primary image Rₚᵣ from the outer surface of the windshield.

FIG. 2 shows reflection vs. angle of incident light with different polarization. FIG. 2(a) shows the reflection from air to glass; and FIG. 2(b) shows the reflection from glass to air.

FIG. 3 shows when the incident light is projected normal to the half waveplate film and the angle of the optical axis relative to the projection of the s-polarization direction of the incident light onto the plane of the half waveplate film is 45° C. FIG. 3(a) shows when the light input the half waveplate film is s-polarized and the light output of is p-polarization; and FIG. 3(b) shows when the light input the half waveplate film is p-polarized and the light output of is s-polarized.

FIG. 4 shows when the incident light is projected at an angle Ѳ relative to the normal axis of the half waveplate film and the angle of the optical axis relative to the projection of the s-polarization direction of the incident light onto the plane of the half waveplate film is 45° C. FIG. 4(a) shows when the light input to the half waveplate film is s-polarized and the light output is majority p-polarized with a minor amount of s-polarized light; and FIG. 4(b) shows when the light input to the half waveplate film is p-polarized and the light output is majority s-polarized with a minor amount of p-polarized light.

FIG. 5 shows the simulated effect of the s-polarized light (λ=550 nm) projected at various incident angles Ѳ on a half waveplate having a Rₑ of 275 nm and Rtₕ of 0 nm. FIG. 5(a) shows the effect of the primary image Rₚᵣ vs O. FIG. 5(b) shows the effect of the ghost image R_{gh} vs Ѳ at different Φ. FIG. 5(C) shows the contrast ratio of Rₚᵣ/R_{gh} vs Ѳ at different Φ.

FIG. 6 shows the simulated effect of the s-polarized light (λ=550 nm) projected at various incident angles Ѳ on a half waveplate having a Rₑ of 275 nm and Rₜₕ of 0 nm. FIG. 6(a) shows the effect of the primary image Rₚᵣ vs ϕ at different O. FIG. 6(b) shows the effect of the ghost image R_{gh} vs ϕ at different Ѳ. FIG. 6(C) shows the contrast ratio of Rₚᵣ/R_{gh} vs ϕ at different Ѳ.

FIG. 7 shows the simulated effect of the s-polarized light (λ=550 nm) projected at various incident angles Ѳ on a half waveplate having a Rₑ of 275 nm and Rₜₕ of -137 nm. FIG. 7(a) shows the effect of the primary image Rₚᵣ vs Ѳ. FIG. 7(b) shows the effect of the ghost image R_{gh} vs Ѳ at different ϕ. FIG. 7(C) shows the contrast ratio of Rₚᵣ/R_{gh} vs Ѳ at different ϕ.

FIG. 8 shows the simulated effect of the s-polarized light (λ=550 nm) projected at various incident angles Ѳ on a half waveplate having a Rₑ of 275 nm and Rₜₕ of -137 nm. FIG. 8(a) shows the effect of the primary image Rₚᵣ vs ϕ at different Ѳ. FIG. 8(b) shows the effect of the ghost image R_{gh} vs ϕ at different Ѳ. FIG. 8(C) shows the contrast ratio of Rₚᵣ/R_{gh} vs ϕ at different Ѳ.

FIG. 9 shows the simulated effect of the s-polarized light (λ=550 nm) projected at various incident angles Ѳ on a half waveplate having a Rₑ of 275 nm and Rₜₕ of -275 nm. FIG. 9(a) shows the effect of the primary image Rₚᵣ vs Ѳ. FIG. 9(b) shows the effect of the ghost image R_{gh} vs Ѳ at different ϕ. FIG. 9(C) shows the contrast ratio of Rₚᵣ/R_{gh} vs Ѳ at different ϕ.

FIG. 10 shows the simulated effect of the s-polarized light (λ=550 nm) projected at various incident angles Ѳ on a half waveplate having a Rₑ of 275 nm and Rₜₕ of -275 nm. FIG. 10(a) shows the effect of the primary image Rₚᵣ vs ϕ at different Ѳ. FIG. 10(b) shows the effect of the ghost image R_{gh} vs ϕ at different Ѳ. FIG. 10(C) shows the contrast ratio of Rₚᵣ/R_{gh} vs ϕ at different Ѳ.

FIG. 11 shows the calculated optical retardation and dispersion of four hypothetical HWP; FD, RD1, RD2, and RD3. FIG. 11(a) shows the in-plane retardation (Rₑ) at various wavelengths for the four hypothetical HWP. FIG. 11(b) shows the out-of-plane retardation (Rₜₕ) at various wavelengths for the four hypothetical HWP.

FIG. 12 shows the four hypothetical HWP; FD, RD1, RD2, and RD3; with different optical wavelength dispersions for s-pol incident light (λ=550 nm). FIG. 12(a) shows the reflection of the ghost image (R_{gh}) the four hypothetical HWP. FIG. 12(b) shows the contrast ratio Rₚᵣ/R_{gh} vs. the wavelength.

FIG. 13 shows different scenarios for linearly polarized LCD projector combined with a 90° TN-LCD. FIG. 13(a) shows that when the TN-LCD is off s-polarized light is converted to p-polarized light. FIG. 13(b) show that when the TN-LCD is on, the s-polarized light remains the same. FIG. 13(c) shows that when the TN-LCD is off, the p-polarized light is converted to s-polarized light. Finally, in FIG. 13(d), when the TN-LCD is on the p-polarized light remains the same.

FIG. 14 shows different scenarios for non-polarizing projector combined with a linear polarizer and a 90° TN-LCD. The linear polarizer generates s-pol or p-pol from non-polarized light. In FIG. 14(a) when TN-LCD is off, the s-polarized light is converted to p-polarized light. FIG. 15(b) shows when the TN-LCD is on, the s-polarized light remains the same. FIG. 14(c) shows when the TN-LCD is off, the p-polarized light is converted to s-polarized light. Finally, FIG. 14(d) shows when the TN-LCD is on, the p-polarized light remains the same.

### DETAILED DESCRIPTION

The present invention may be understood more readily by reference to the following detailed description of the invention and the examples provided therein. It is to be understood that this invention is not limited to the specific methods, formulations, and conditions described, as such may vary. It is also to be understood that the terminology used herein is for the purpose of describing particular aspects of the invention only and is not intended to be limiting.

### Definitions

In this specification and in the claims that follow, reference will be made to a number of terms, which shall be defined to have the following meanings.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

The “optical axis” is the axis formed along the fast axis in the film plane when the film is a negative birefringent (retardation) film, and the optical axis is the axis formed along the slow axis in the film plane when the film is a positive birefringent (retardation) film. The fast axis is the axis having the smaller refractive index in the film plane, and the slow axis is the axis having the larger refractive index in the film plane.

The use of an adhesion promoter may help to improve interfacial adhesion between dissimilar materials. As used herein, an “adhesion promoter” is any material that increases or improves the interfacial adhesion between two dissimilar materials, such as the polymer layer (i.e., PVB) and the optical film. Any adhesion promoter that improves the interfacial adhesion while not interfering with the properties of the polymer layer(s) and optical film may be used. Examples of adhesion promoters include, but are not limited to, silanes, acrylates and methacrylates, acids, acid scavengers such as epoxide acid scavengers, and epoxy and the like. The adhesion promoter(s) can be blended into the material, incorporated into it prior to forming (such as extrusion), or added to or coated onto a surface or layer using methods known to one skilled in the art. The adhesion promoter can also be reacted on the surface where improved adhesion is desired.

The plasticizer used in the plasticizer composition below can be any that is known in the art. The plasticizer in the plasticizer composition can comprise a combination of two or more plasticizers. The plasticizer can be either monomeric or polymeric in structure. In various embodiments, the plasticizer can be a compound having a hydrocarbon segment of 30 or less, 25 or less, 20 or less, 15 or less, 12 or less, or 10 or less carbon atoms and at least 6 carbon atoms. Suitable conventional plasticizers for use in these interlayers include, for example, esters of a polybasic acid or a polyhydric alcohol, among others. Suitable plasticizers include, for example, triethylene glycol di-(2-ethylhexanoate) (“3GEH”), triethylene glycol di-(2-ethylbutyrate), triethylene glycol diheptanoate, tetraethylene glycol diheptanoate, dihexyl adipate, dioctyl adipate, hexyl cyclohexyladipate, diisononyl adipate, heptylnonyl adipate, dibutyl sebacate, butyl ricinoleate, castor oil, dibutoxy ethyl phthalate, diethyl phthalate, dibutyl phthalate, trioctyl phosphate, triethyl glycol ester of coconut oil fatty acids, phenyl ethers of polyethylene oxide rosin derivatives, oil modified sebacic alkyd resins, tricresyl phosphate, and mixtures thereof. In certain embodiments, the plasticizer is 3GEH.

Additionally, other plasticizers, such as high refractive index plasticizers, may also be used, either alone or in combination with another plasticizer. As used herein, the term “high refractive index plasticizer,” refers to a plasticizer having a refractive index of at least 1.460. The high refractive index plasticizers may increase or reduce the refractive index of one or more of the layers, which may improve the optical properties of the interlayer, including mottle, haze, and/or clarity. In embodiments, the high RI plasticizers suitable for use can have a refractive index of at least 1.460, at least 1.470, at least 1.480, at least 1.490, at least 1.500, at least 1.510, at least 1.520 and/or not more than 1.600, not more than 1.575, or not more than 1.550, measured as discussed above.

When the resin layer or interlayer includes a high RI plasticizer, the plasticizer can be present in the layer alone or it can be blended with one or more additional plasticizers. Examples of types or classes of high refractive index plasticizers can include, but are not limited to, polyadipates (RI of 1.460 to 1.485); epoxides such as epoxidized soybean oils (RI of 1.460 to 1.480); phthalates and terephthalates (RI of 1.480 to 1.540); benzoates and toluates (RI of 1.480 to 1.550); and other specialty plasticizers (RI of 1.490 to 1.520). Specific examples of suitable RI plasticizers can include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bisphenol A bis(2-ethylhexaonate), di-(butoxyethyl) terephthalate, di-(butoxyethyoxyethyl) terephthalate, and mixtures thereof. In embodiments, the high RI plasticizer may be selected from dipropylene glycol dibenzoate and tripropylene glycol dibenzoate, and/or 2,2,4-trimethyl-1,3-pentanediol dibenzoate. In various embodiments, the plasticizer can be selected from at least one of the following: benzoates, phthalates, phosphates, arylene-bis(diaryl phosphate), and isophthalates.

Other useful plasticizers include triphenyl phosphate, tricresyl phosphate, cresyldiphenyl phosphate, octyldiphenyl phosphate, diphenylbiphenyl phosphate, trioctyl phosphate, tributyl phosphate, diethyl phthalate, dimethoxyethyl phthalate, dimethyl phthalate, dioctyl phthalate, dibutyl phthalate, di-2-ethylhexyl phthalate, butylbenzyl phthalate, dibenzyl phthalate, butyl phthalyl butyl glycolate, ethyl phthalyl ethyl glycolate, methyl phthalyl ethyl glycolate, triethyl citrate, tri-n-butyl citrate, acetyltriethyl citrate, acetyl-tri-n-butyl citrate, and acetyl-tri-n-(2-ethylhexyl) citrate

### Interlayer

The present application discloses an interlayer, comprising: (a) a first polymer layer; and (b) a half waveplate (“HWP”) film comprising a polymeric material, wherein the HWP film has a plane and an optical axis, wherein the optical axis has an angle phi (ϕ) relative to the axis formed from the p-polarization direction of a display light projected onto the plane of the HWP film, wherein ϕ is from an angle of 30° to less than 45°, an angle of greater than 45° to 55°, an angle of greater than 135° to 150°, or an angle of 125° to less than 135°, and wherein the HWP film exhibits an in-plane retardation measured at 550 nm (“Rₑ[550 nm]”) of from -200 nm to -350 nm or from 200 nm to 350 nm, and an out-of-plane retardation measured at 550 nm (“Rₜₕ[550 nm]”) of from -350 nm to 350 nm.

In one embodiment, ϕ is from 35° to 43° or from 137° to 145°. In one embodiment, ϕ is from 40° to 43° or from 137° to 140°. In one embodiment, ϕ is from 38° to 44° or from 136° to 142°. In one embodiment, ϕ is from 38° to 43° or from 137° to 142°. In one embodiment, ϕ is from 36° to 39° or from 141° to 144°

In one embodiment, the HWP film exhibits: (1) an Rₑ[550 nm] that is from -220 nm to -325 nm or from 220 nm to 325 nm, and a Rₜₕ[550 nm] that is from -275 nm to 275 nm; or (2) an Rₑ[550 nm] that is from -250 nm to -300 nm or from 250 nm to 300 nm, and a Rₜₕ[550 nm] that is from -150 nm to 150 nm.

In one class of this embodiment, the HWP film exhibits a ratio of Rₜₕ[550 nm] to Rₑ[550 nm] for the HWP film is from -0.2 to 0.2, and wherein ϕ is from 42° to less than 45°, greater than 45° to 52° or from greater than 135° to 138°, from 128° to less than 135°.

In one subclass of this class, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one subclass of this class, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one subclass of this class, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits a ratio of Rₜₕ[550 nm] to Rₑ[550 nm] for the HWP film is from -1.2 to -0.8, and ϕ is from 30° to 40° or from 140° to 150°.

In one subclass of this class, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one subclass of this class, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one subclass of this class, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits a ratio of Rₜₕ[550 nm] to Rₑ[550 nm] for the HWP film is from -0.8 to -0.2, and ϕ is from 36° and 44° or from 136° to 144°.

In one subclass of this class, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one subclass of this class, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one subclass of this class, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits a ratio of Rₜₕ[550 nm] to Rₑ[550 nm] for the HWP film is from -2.0 to -1.2, and ϕ is from 30° to 38° or from 142° to 150°.

In one subclass of this class, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one subclass of this class, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one subclass of this class, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits an Rₑ[550 nm] that is from -220 nm to -325 nm or from 220 nm to 325 nm.

In one subclass of this class, the HWP film exhibits a ratio of Rₜₕ[550 nm] to Rₑ[550 nm] for the HWP film is from -0.2 to 0.2, and wherein ϕ is from 42° to less than 45°, greater than 45° to 52° or from greater than 135° to 138°, from 128° to less than 135°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -1.2 to -0.8, and ϕ is from 30° to 40° or from 140° to 150°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -0.8 to -0.2, and ϕ is from 36° and 44° or from 136° to 144°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -2.0 to -1.2, and ϕ is from 30° to 38° or from 142° to 150°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits an Rₑ[550 nm] that is from -250 nm to -300 nm or from 250 nm to 300 nm, and a Rₜₕ[550 nm] that is from -150 nm to 150 nm.

In one subclass of this class, the HWP film exhibits a ratio of Rₜₕ[550 nm] to Rₑ[550 nm] for the HWP film is from -0.2 to 0.2, and wherein ϕ is from 42° to less than 45°, greater than 45° to 52° or from greater than 135° to 138°, from 128° to less than 135°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -1.2 to -0.8, and ϕ is from 30° to 40° or from 140° to 150°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -0.8 to -0.2, and ϕ is from 36° and 44° or from 136° to 144°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -2.0 to -1.2, and ϕ is from 30° to 38° or from 142° to 150°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one embodiment, the ratio of Rₜₕ[550 nm] to Rₑ[550 nm] for the HWP film is from -0.2 to 0.2, and wherein ϕ is from 42° to less than 45°, greater than 45° to 52° or from greater than 135° to 138°, from 128° to less than 135°. In one embodiment, the ratio of Rₜₕ[550 nm] to Rₑ[550 nm] for the HWP film is from -1.2 to -0.8, and ϕ is from 30° to 40° or from 140° to 150°. In one embodiment, the ratio of Rₜₕ[550 nm] to Rₑ[550 nm] for the HWP film is from -0.8 to -0.2, and ϕ is from 36° and 44° or from 136° to 144°. In one embodiment, the ratio of Rₜₕ[550 nm] to Rₑ[550 nm] for the HWP film is from -2.0 to -1.2, and ϕ is from 30° to 38° or from 142° to 150°. In one embodiment, (1) the ratio of Rₜₕ[550 nm] to Rₑ[550 nm] for the HWP film is from -0.2 to 0.2, and wherein ϕ is from 42° to less than 45°, greater than 45° to 52° or from greater than 135° to 138°, from 128° to less than 135° ; (2) the ratio of Rₜₕ[550 nm] to Rₑ[550 nm] for the HWP film is from -1.2 to -0.8, and ϕ is from 30° to 40° or from 140° to 150°; (3) the ratio of Rₜₕ[550 nm] to Rₑ[550 nm] for the HWP film is from -0.8 to -0.2, and ϕ is from 36° and 44° or from 136° to 144°; or (4) the ratio of Rₜₕ[550 nm] to Rₑ[550 nm] for the HWP film is from -2.0 to -1.2, and ϕ is from 30° to 38° or from 142° to 150°.

In one embodiment, the HWP film is a single layer or multilayer film. In one class of this embodiment, the HWP film is a single layer film. In one class of this embodiment, the HWP film is a multilayer film. In one subclass of this class, the multilayer film is a stack of two quarter waveplate films.

In one embodiment, the polymeric material comprises a cellulose ester, a polycarbonate, a co-polycarbonate, a cyclic olefin polymer, a cyclic olefin copolymer, a polyester, a co-polyester, a polymerized thermotropic liquid crystal, a dried lyotropic liquid crystal or combinations thereof.

In one class of this embodiment, the polymeric material comprises a cellulose ester. In one subclass of this class, the polymeric material further comprises a plasticizer composition.

In one class of this embodiment, the cellulose ester is a regioselectively substituted cellulose ester. In one subclass of this class, the polymeric material further comprises a plasticizer composition.

In one class of this embodiment, the polymeric material comprises a polycarbonate. In one subclass of this class, the polymeric material further comprises a plasticizer composition.

In one class of this embodiment, the polymeric material comprises a co-polycarbonate. In one subclass of this class, the polymeric material further comprises a plasticizer composition.

In one class of this embodiment, the polymeric material comprises a cyclic olefin polymer. In one subclass of this class, the polymeric material further comprises a plasticizer composition.

In one class of this embodiment, the polymeric material comprises a cellulose ester, a polyester. In one subclass of this class, the polymeric material further comprises a plasticizer composition.

In one class of this embodiment, the polymeric material comprises a co-polyester. In one subclass of this class, the polymeric material further comprises a plasticizer composition.

In one class of this embodiment, the polymeric material comprises a polymerized thermotropic liquid crystal. In one subclass of this class, the polymeric material further comprises a plasticizer composition.

In one class of this embodiment, the polymeric material comprises a dried lyotropic liquid crystal. In one subclass of this class, the polymeric material further comprises a plasticizer composition.

In one embodiment, the first polymer layer is made up of multiple layers.

In one embodiment, the first polymer layer comprises a first polymer composition comprising a poly(vinylacetal), a polyurethane, a poly(ethylene-co-vinyl)acetate, a polyvinyl chloride, a poly(vinylchloride-co-methacrylate), a polyethylene, a polyolefin, an ethylene acrylate ester copolymer, a poly(ethylene-co-butyl acrylate), a silicone elastomer, or an epoxy resin. In one class of this embodiment, the polymeric material further comprises a plasticizer composition.

In one class of this embodiment, the first polymer composition comprises a poly(vinylacetal). In one subclass of this class, the polymeric material further comprises a plasticizer composition. In one subclass of this class, the poly(vinylacetal) is a poly(vinyl butyral). In one subclass of this class, the polymeric material further comprises a plasticizer composition.

In one class embodiment, the first polymer composition comprises a polyurethane. In one subclass of this class, the polymeric material further comprises a plasticizer composition.

In one class of this embodiment, the first polymer composition comprises a poly(ethylene-co-vinyl)acetate. In one subclass of this class, the polymeric material further comprises a plasticizer composition.

In one class of this embodiment, the first polymer composition comprises a polyvinyl chloride. In one subclass of this class, the polymeric material further comprises a plasticizer composition.

In one class of this embodiment, the first polymer composition comprises a poly(vinylchloride-co-methacrylate). In one subclass of this class, the polymeric material further comprises a plasticizer composition.

In one class of this embodiment, the first polymer layer comprises a first polymer composition comprises a polyethylene. In one subclass of this class, the polymeric material further comprises a plasticizer composition.

In one class of this embodiment, the first polymer composition comprises a polyolefin. In one subclass of this class, the polymeric material further comprises a plasticizer composition.

In one class of this embodiment, the first polymer composition comprises an ethylene acrylate ester copolymer. In one subclass of this class, the polymeric material further comprises a plasticizer composition.

In one class of this embodiment, the first polymer composition comprises a poly(ethylene-co-butyl acrylate). In one subclass of this class, the polymeric material further comprises a plasticizer composition.

In one class of this embodiment, the first polymer composition comprises a silicone elastomer. In one subclass of this class, the polymeric material further comprises a plasticizer composition.

In one class of this embodiment, the first polymer composition comprises an epoxy resin. In one subclass of this class, the polymeric material further comprises a plasticizer composition.

In one embodiment, the interlayer further comprises a second polymer layer, wherein the HWP film is disposed between the first polymer layer and the second polymer layer.

In one class of this embodiment, the second polymer layer is made up of multiple layers.

In one class of this embodiment, the second polymer layer comprises a second polymer composition comprising a poly(vinylacetal), a polyurethane, a poly(ethylene-co-vinyl)acetate, a polyvinyl chloride, a poly(vinylchloride-co-methacrylate), a polyethylene, a polyolefin, an ethylene acrylate ester copolymer, a poly(ethylene-co-butyl acrylate), a silicone elastomer, or an epoxy resin. In one subclass of this class, the polymeric material further comprises a plasticizer composition.

In one class embodiment, the second polymer composition comprises a polyurethane. In one subclass of this class, the polymeric material further comprises a plasticizer composition.

In one class of this embodiment, the second polymer composition comprises a poly(ethylene-co-vinyl)acetate. In one subclass of this class, the polymeric material further comprises a plasticizer composition.

In one class of this embodiment, the second polymer composition comprises a polyvinyl chloride. In one subclass of this class, the polymeric material further comprises a plasticizer composition.

In one class of this embodiment, the second polymer composition comprises a poly(vinylchloride-co-methacrylate). In one subclass of this class, the polymeric material further comprises a plasticizer composition.

In one class of this embodiment, the second polymer layer comprises a second polymer composition comprises a polyethylene. In one subclass of this class, the polymeric material further comprises a plasticizer composition.

In one class of this embodiment, the second polymer composition comprises a polyolefin. In one subclass of this class, the polymeric material further comprises a plasticizer composition.

In one class of this embodiment, the second polymer composition comprises an ethylene acrylate ester copolymer. In one subclass of this class, the polymeric material further comprises a plasticizer composition.

In one class of this embodiment, the second polymer composition comprises a poly(ethylene-co-butyl acrylate). In one subclass of this class, the polymeric material further comprises a plasticizer composition.

In one class of this embodiment, the second polymer composition comprises a silicone elastomer. In one subclass of this class, the polymeric material further comprises a plasticizer composition.

In one class of this embodiment, the second polymer composition comprises an epoxy resin. In one subclass of this class, the polymeric material further comprises a plasticizer composition.

In one embodiment, the HWP film has a first barrier coating on a first side in contact with the first polymer layer.

In one class of this embodiment, the first barrier coating comprises a UV curable coating. In one subclass of this class, the UV curable coating for the first barrier coating is an acrylate coating.

In one class of this embodiment, the interlayer further comprises a second polymer layer, and the HWP film has a second barrier coating on a second side in contact with the second polymer layer. In one subclass of this class, the second barrier coating comprises a UV curable coating. In one sub-subclass of this subclass, the UV curable coating for the second barrier coating is an acrylate coating.

In one subclass of this class, the first barrier coating and second barrier coating each comprises a UV curable coating. In a sub-subclass of this subclass, the UV curable coating for the first barrier coating and the second barrier coating are each an acrylate coating.

In one class of this embodiment, the interlayer further comprises a second polymer layer, and the HWP film has a second barrier coating on a second side in contact with the second polymer layer, and wherein the first barrier coating and the second barrier coatings each comprises a UV curable coating, wherein the UV curable coatings are each an acrylate coating.

In one embodiment, the interlayer further comprises an adhesion promoter. In one class of this embodiment, the adhesion promoter comprises a silane, an acrylate, a methacrylate, an acid, an acid scavenger (e.g., epoxide), or an epoxy compound. In one subclass of this class, the adhesion promoter comprises a silane compound. In one subclass of this class, the adhesion promoter comprises an acrylate compound. In one subclass of this class, the adhesion promoter comprises a methacrylate compound. In one subclass of this class, the adhesion promoter comprises an acid compound. In one subclass of this class, the adhesion promoter comprises an epoxy compound.

In one embodiment, the present application discloses a head-up display system a head-up display system a head-up display system, comprising: (1) an article comprising: (i) a first rigid substrate having a first outer surface and a first normal axis; (ii) a second rigid substrate having a second outer surface; and (iii) any interlayer disclosed herein.

In one class of this embodiment, the system exhibits a projected image in which the intensity ratio of the primary image to the secondary (ghost) image is greater than 5. In one class of this embodiment, the system exhibits a projected image in which the intensity ratio of the primary image to the secondary (ghost) image is greater than 30. In one class of this embodiment, the system exhibits a projected image in which the intensity ratio of the primary image to the secondary (ghost) image is greater than 70. In one class of this embodiment, the system exhibits a projected image in which the intensity ratio of the primary image to the secondary (ghost) image is greater than 80. In one class of this embodiment, the system exhibits a projected image in which the intensity ratio of the primary image to the secondary (ghost) image is greater than 90.

In one class of this embodiment, the system further comprises an adhesion promoter. In one subclass of this class, the adhesion promoter comprises a silane, an acrylate, a methacrylate, an acid, an acid scavenger (e.g., epoxide), or an epoxy compound.

In one class of this embodiment, the system further comprises (2) a display device for generating the display light as polarized light, and wherein the display light comprises information. In one subclass of this class, the system further comprises a polarization rotator. In one sub-subclass of this subclass, the polarization rotator is a passive polarization rotator or an active polarization rotator. In one sub-subclass of this subclass, the polarization rotator is a passive polarization rotator. In one sub-sub-subclass of this sub-subclass, the passive polarization rotator is a HWP film. In one sub-subclass of this subclass, the polarization rotator is an active polarization rotator. In one sub-subclass of this subclass, the active polarization rotator is (i) an active twisted nematic liquid crystal device (“TN-LCD”), (ii) an active electrically controlled birefringence liquid crystal device (“ECB-LCD”), or (iii) an active vertically aligned liquid crystal device (“VA-LCD”). In a subclass of this class, the display light is projected incident on the first outer surface at an angle of incidence (Ѳ) relative to the first normal axis, wherein (Ѳ) is from 45° to 70°.

In one class of this embodiment, the system further comprises (2) a display device for generating the display light, wherein the display light comprises information; and (3) a light polarizing device for polarizing the display light. In one subclass of this class, the system further comprises a polarization rotator. In one sub-subclass of this subclass, the polarization rotator is a passive polarization rotator or an active polarization rotator. In one sub-subclass of this subclass, the polarization rotator is a passive polarization rotator. In one sub-sub-subclass of this sub-subclass, the passive polarization rotator is a HWP film. In one sub-subclass of this subclass, the polarization rotator is an active polarization rotator. In one sub-subclass of this subclass, the active polarization rotator is (i) an active twisted nematic liquid crystal device (“TN-LCD”), (ii) an active electrically controlled birefringence liquid crystal device (“ECB-LCD”), or (iii) an active vertically aligned liquid crystal device (“VA-LCD”). In a subclass of this class, the display light is projected incident on the first outer surface at an angle of incidence (Ѳ) relative to the first normal axis, wherein Ѳ is from 45° to 70°.

In one embodiment, the interlayer is incorporated into an automobile.

### Head-Up Display System

The present application discloses a head-up display system, comprising: (1) an article comprising: (i) a first rigid substrate having a first outer surface and a first normal axis; (ii) a second rigid substrate having a second outer surface; and (iii) an interlayer, comprising: (a) a first polymer layer; and (b) a half waveplate (“HWP”) film comprising a polymeric material, wherein the HWP film has a plane and an optical axis, wherein the optical axis has an angle phi (ϕ) relative to the axis formed from the p-polarization direction of a display light projected onto the plane of the HWP film, wherein ϕ is from an angle of 30° to less than 45°, an angle of greater than 45° to 55°, an angle of greater than 135° to 150°, or an angle of 125° to less than 135°, and wherein the HWP film exhibits an in-plane retardation measured at 550 nm (“Rₑ[550 nm]”) of from -200 nm to -350 nm or from 200 nm to 350 nm, and an out-of-plane retardation measured at 550 nm (“Rₜₕ[550 nm]”) of from -350 nm to 350 nm, wherein the interlayer is disposed between the first rigid substrate and the second rigid substrate.

In one embodiment, the system exhibits a projected image in which the intensity ratio of the primary image to the secondary (ghost) image is greater than 5. In one embodiment, the system exhibits a projected image in which the intensity ratio of the primary image to the secondary (ghost) image is greater than 10. In one embodiment, the system exhibits a projected image in which the intensity ratio of the primary image to the secondary (ghost) image is greater than 20. In one embodiment, the system exhibits a projected image in which the intensity ratio of the primary image to the secondary (ghost) image is greater than 30. In one embodiment, the system exhibits a projected image in which the intensity ratio of the primary image to the secondary (ghost) image is greater than 40. In one embodiment, the system exhibits a projected image in which the intensity ratio of the primary image to the secondary (ghost) image is greater than 50. In one embodiment, the system exhibits a projected image in which the intensity ratio of the primary image to the secondary (ghost) image is greater than 60. In one embodiment, the system exhibits a projected image in which the intensity ratio of the primary image to the secondary (ghost) image is greater than 70. In one embodiment, the system exhibits a projected image in which the intensity ratio of the primary image to the secondary (ghost) image is greater than 80. In one embodiment, the system exhibits a projected image in which the intensity ratio of the primary image to the secondary (ghost) image is greater than 85. In one embodiment, the system exhibits a projected image in which the intensity ratio of the primary image to the secondary (ghost) image is greater than 90. In one embodiment, the system exhibits a projected image in which the intensity ratio of the primary image to the secondary (ghost) image is greater than 95.

In one embodiment, ϕ is from 35° to 43° or from 137° to 145°. In one embodiment, ϕ is from 40° to 43° or from 137° to 140°. In one embodiment, ϕ is from 38° to 44° or from 136° to 142°. In one embodiment, ϕ is from 38° to 43° or from 137° to 142°. In one embodiment, ϕ is from 36° to 39° or from 141° to 144°

In one embodiment, the article further comprises an adhesion promoter. In one class of this embodiment, the adhesion promoter comprises a silane, an acrylate, a methacrylate, an acid, an acid scavenger (e.g., epoxide), or an epoxy compound. In one subclass of this class, the adhesion promoter comprises a silane compound. In one subclass of this class, the adhesion promoter comprises an acrylate compound. In one subclass of this class, the adhesion promoter comprises a methacrylate compound. In one subclass of this class, the adhesion promoter comprises an acid compound. In one subclass of this class, the adhesion promoter comprises an epoxy compound.

In one embodiment, the head-up display further comprises (2) a display device for generating the display light as polarized light, and wherein the display light comprises information.

In one embodiment, the head-up display further comprising (2) a display device for generating the display light, wherein the display light comprises information; and (3) a light polarizing device for polarizing the display light.

In one class of this embodiment, system further comprises a polarization rotator. In one subclass of this class, the polarization rotator is a passive polarization rotator or an active polarization rotator. In one subclass of this class, the polarization rotator is a passive polarization rotator. In one sub-sub-subclass of this sub-subclass, the passive polarization rotator is a HWP film. In one subclass of this class, the polarization rotator is an active polarization rotator. In one sub-subclass of this subclass, the active polarization rotator is (i) an active twisted nematic liquid crystal device (“TN-LCD”), (ii) an active electrically controlled birefringence liquid crystal device (“ECB-LCD”), or (iii) an active vertically aligned liquid crystal device (“VA-LCD”). In a subclass of this class, the display light is projected incident on the first outer surface at an angle of incidence (Ѳ) relative to the first normal axis, wherein Ѳ is from 45° to 70°.

In one embodiment, the HWP film exhibits: (1) an Rₑ[550 nm] that is from -220 nm to -325 nm or from 220 nm to 325 nm, and a Rₜₕ[550 nm] that is from -275 nm to 275 nm; or (2) an Rₑ[550 nm] that is from -250 nm to -300 nm or from 250 nm to 300 nm, and a Rₜₕ[550 nm] that is from -150 nm to 150 nm.

In one class of this embodiment, the HWP film exhibits a ratio of Rₜₕ[550 nm] to Rₑ[550 nm] for the HWP film is from -0.2 to 0.2, and wherein ϕ is from 42° to less than 45°, greater than 45° to 52° or from greater than 135° to 138°, from 128° to less than 135°.

In one subclass of this class, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one subclass of this class, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one subclass of this class, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits a ratio of Rₜₕ[550 nm] to Rₑ[550 nm] for the HWP film is from -1.2 to -0.8, and ϕ is from 30° to 40° or from 140° to 150°.

In one subclass of this class, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one subclass of this class, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one subclass of this class, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits a ratio of Rₜₕ[550 nm] to Rₑ[550 nm] for the HWP film is from -0.8 to -0.2, and ϕ is from 36° and 44° or from 136° to 144°.

In one subclass of this class, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one subclass of this class, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one subclass of this class, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits a ratio of Rₜₕ[550 nm] to Rₑ[550 nm] for the HWP film is from -2.0 to -1.2, and ϕ is from 30° to 38° or from 142° to 150°.

In one subclass of this class, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one subclass of this class, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one subclass of this class, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits an Rₑ[550 nm] that is from -220 nm to -325 nm or from 220 nm to 325 nm.

In one subclass of this class, the HWP film exhibits a ratio of Rₜₕ[550 nm] to Rₑ[550 nm] for the HWP film is from -0.2 to 0.2, and wherein ϕ is from 42° to less than 45°, greater than 45° to 52° or from greater than 135° to 138°, from 128° to less than 135°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -1.2 to -0.8, and ϕ is from 30° to 40° or from 140° to 150°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -0.8 to -0.2, and ϕ is from 36° and 44° or from 136° to 144°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -2.0 to -1.2, and ϕ is from 30° to 38° or from 142° to 150°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one class of this embodiment, the HWP film exhibits an Rₑ[550 nm] that is from -250 nm to -300 nm or from 250 nm to 300 nm, and a Rₜₕ[550 nm] that is from -150 nm to 150 nm.

In one subclass of this class, the HWP film exhibits a ratio of Rₜₕ[550 nm] to Rₑ[550 nm] for the HWP film is from -0.2 to 0.2, and wherein ϕ is from 42° to less than 45°, greater than 45° to 52° or from greater than 135° to 138°, from 128° to less than 135°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -1.2 to -0.8, and ϕ is from 30° to 40° or from 140° to 150°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -0.8 to -0.2, and Φ is from 36° and 44° or from 136° to 144°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one subclass of this class, the HWP film exhibits a ratio of Rₜₕ[550 nm] to Rₑ[550 nm] for the HWP film is from -2.0 to -1.2, and Φ is from 30° to 38° or from 142° to 150°.

In one sub-subclass of this subclass, the HWP film exhibits a ratio of Rₑ[450 nm] to Rₑ[550 nm] for the HWP film is from 0.75 to 1.10, and a ratio of Rₑ[650 nm] to Rₑ[550 nm] for the HWP film is from 0.95 to 1.25. In one sub-subclass of this subclass, the HWP film exhibits a ratio of Rₑ[450 nm] to Rₑ[550 nm] for the HWP film is from 0.80 to 1.0, and a ratio of Rₑ[650 nm] to Rₑ[550 nm] for the HWP film is from 1.0 to 1.25. In one sub-subclass of this subclass, the HWP film exhibits a ratio of Rₑ[450 nm] to Rₑ[550 nm] for the HWP film is from 0.82 to 0.90, and a ratio of Rₑ[650 nm] to Rₑ[550 nm] for the HWP film is from 1.05 to 1.18.

In one embodiment, the ratio of Rₜₕ[550 nm] to Rₑ[550 nm] for the HWP film is from -0.2 to 0.2, and wherein Φ is from 42° to less than 45°, greater than 45° to 52° or from greater than 135° to 138°, from 128° to less than 135°. In one embodiment, the ratio of Rₜₕ[550 nm] to Rₑ[550 nm] for the HWP film is from -1.2 to -0.8, and Φ is from 30° to 40° or from 140° to 150°. In one embodiment, the ratio of Rₜₕ[550 nm] to Rₑ[550 nm] for the HWP film is from -0.8 to -0.2, and Φ is from 36° and 44° or from 136° to 144°. In one embodiment, the ratio of Rₜₕ[550 nm] to Rₑ[550 nm] for the HWP film is from -2.0 to -1.2, and Φ is from 30° to 38° or from 142° to 150°. In one embodiment, (1) the ratio of Rₜₕ[550 nm] to Rₑ[550 nm] for the HWP film is from -0.2 to 0.2, and wherein Φ is from 42° to less than 45°, greater than 45° to 52° or from greater than 135° to 138°, from 128° to less than 135° ; (2) the ratio of Rₜₕ[550 nm] to Rₑ[550 nm] for the HWP film is from -1.2 to -0.8, and Φ is from 30° to 40° or from 140° to 150°; (3) the ratio of Rₜₕ[550 nm] to Rₑ[550 nm] for the HWP film is from -0.8 to -0.2, and Φ is from 36° and 44° or from 136° to 144°; or (4) the ratio of Rₜₕ[550 nm] to Rₑ[550 nm] for the HWP film is from -2.0 to -1.2, and Φ is from 30° to 38° or from 142° to 150°.

In one embodiment, the HWP film is a single layer or multilayer film. In one class of this embodiment, the HWP film is a single layer film. In one class of this embodiment, the HWP film is a multilayer film. In one subclass of this class, the multilayer film is a stack of two quarter waveplate films.

In one embodiment, the polymeric material comprises a cellulose ester, a polycarbonate, a co-polycarbonate, a cyclic olefin polymer, a cyclic olefin copolymer, a polyester, a co-polyester, a polymerized thermotropic liquid crystal, a dried lyotropic liquid crystal or combinations thereof. In one class of this embodiment, the polymeric material further comprises a plasticizer.

In one class of this embodiment, the polymeric material comprises a cellulose ester. In one subclass of this class, the polymeric material further comprises a plasticizer composition.

In one class of this embodiment, the cellulose ester is a regioselectively substituted cellulose ester. In one subclass of this class, the polymeric material further comprises a plasticizer composition.

In one class of this embodiment, the polymeric material comprises a polycarbonate. In one subclass of this class, the polymeric material further comprises a plasticizer composition.

In one class of this embodiment, the polymeric material comprises a co-polycarbonate. In one subclass of this class, the polymeric material further comprises a plasticizer composition.

In one class of this embodiment, the polymeric material comprises a cyclic olefin polymer. In one subclass of this class, the polymeric material further comprises a plasticizer composition.

In one class of this embodiment, the polymeric material comprises a cellulose ester, a polyester. In one subclass of this class, the polymeric material further comprises a plasticizer composition.

In one class of this embodiment, the polymeric material comprises a co-polyester. In one subclass of this class, the polymeric material further comprises a plasticizer composition.

In one class of this embodiment, the polymeric material comprises a polymerized thermotropic liquid crystal. In one subclass of this class, the polymeric material further comprises a plasticizer composition.

In one class of this embodiment, the polymeric material comprises a dried lyotropic liquid crystal. In one subclass of this class, the polymeric material further comprises a plasticizer composition.

In one embodiment, the first polymer layer is made up of multiple layers.

In one embodiment, the first polymer layer comprises a first polymer composition comprising a poly(vinylacetal), a polyurethane, a poly(ethylene-co-vinyl)acetate, a polyvinyl chloride, a poly(vinylchloride-co-methacrylate), a polyethylene, a polyolefin, an ethylene acrylate ester copolymer, a poly(ethylene-co-butyl acrylate), a silicone elastomer, or an epoxy resin. In one class of this embodiment, the polymeric material further comprises a plasticizer composition.

In one class of this embodiment, the first polymer composition comprises a poly(vinylacetal). In one subclass of this class, the polymeric material further comprises a plasticizer composition. In one subclass of this class, the poly(vinylacetal) is a poly(vinyl butyral). In one subclass of this class, the polymeric material further comprises a plasticizer composition.

In one class embodiment, the first polymer composition comprises a polyurethane. In one subclass of this class, the polymeric material further comprises a plasticizer composition.

In one class of this embodiment, the first polymer composition comprises a poly(ethylene-co-vinyl)acetate. In one subclass of this class, the polymeric material further comprises a plasticizer composition.

In one class of this embodiment, the first polymer composition comprises a polyvinyl chloride. In one subclass of this class, the polymeric material further comprises a plasticizer composition.

In one class of this embodiment, the first polymer composition comprises a poly(vinylchloride-co-methacrylate). In one subclass of this class, the polymeric material further comprises a plasticizer composition.

In one class of this embodiment, the first polymer layer comprises a first polymer composition comprises a polyethylene. In one subclass of this class, the polymeric material further comprises a plasticizer composition.

In one class of this embodiment, the first polymer composition comprises a polyolefin. In one subclass of this class, the polymeric material further comprises a plasticizer composition.

In one class of this embodiment, the first polymer composition comprises an ethylene acrylate ester copolymer. In one subclass of this class, the polymeric material further comprises a plasticizer composition.

In one class of this embodiment, the first polymer composition comprises a poly(ethylene-co-butyl acrylate). In one subclass of this class, the polymeric material further comprises a plasticizer composition.

In one class of this embodiment, the first polymer composition comprises a silicone elastomer. In one subclass of this class, the polymeric material further comprises a plasticizer composition.

In one class of this embodiment, the first polymer composition comprises an epoxy resin. In one subclass of this class, the polymeric material further comprises a plasticizer composition.

In one embodiment, the interlayer further comprises a second polymer layer, wherein the HWP film is disposed between the first polymer layer and the second polymer layer.

In one class of this embodiment, the second polymer layer is made up of multiple layers.

In one class of this embodiment, the second polymer layer comprises a second polymer composition comprising a poly(vinylacetal), a polyurethane, a poly(ethylene-co-vinyl)acetate, a polyvinyl chloride, a poly(vinylchloride-co-methacrylate), a polyethylene, a polyolefin, an ethylene acrylate ester copolymer, a poly(ethylene-co-butyl acrylate), a silicone elastomer, or an epoxy resin. In one subclass of this class, the polymeric material further comprises a plasticizer composition.

In one class embodiment, the second polymer composition comprises a polyurethane. In one subclass of this class, the polymeric material further comprises a plasticizer composition.

In one class of this embodiment, the second polymer composition comprises a poly(ethylene-co-vinyl)acetate. In one subclass of this class, the polymeric material further comprises a plasticizer composition.

In one class of this embodiment, the second polymer composition comprises a polyvinyl chloride. In one subclass of this class, the polymeric material further comprises a plasticizer composition.

In one class of this embodiment, the second polymer composition comprises a poly(vinylchloride-co-methacrylate). In one subclass of this class, the polymeric material further comprises a plasticizer composition.

In one class of this embodiment, the second polymer layer comprises a second polymer composition comprises a polyethylene. In one subclass of this class, the polymeric material further comprises a plasticizer composition.

In one class of this embodiment, the second polymer composition comprises a polyolefin. In one subclass of this class, the polymeric material further comprises a plasticizer composition.

In one class of this embodiment, the second polymer composition comprises an ethylene acrylate ester copolymer. In one subclass of this class, the polymeric material further comprises a plasticizer composition.

In one class of this embodiment, the second polymer composition comprises a poly(ethylene-co-butyl acrylate). In one subclass of this class, the polymeric material further comprises a plasticizer composition.

In one class of this embodiment, the second polymer composition comprises a silicone elastomer. In one subclass of this class, the polymeric material further comprises a plasticizer composition.

In one class of this embodiment, the second polymer composition comprises an epoxy resin. In one subclass of this class, the polymeric material further comprises a plasticizer composition.

In one embodiment, the HWP film has a first barrier coating on a first side in contact with the first polymer layer.

In one class of this embodiment, the first barrier coating comprises a UV curable coating. In one subclass of this class, the UV curable coating for the first barrier coating is an acrylate coating.

In one class of this embodiment, the interlayer further comprises a second polymer layer, and the HWP film has a second barrier coating on a second side in contact with the second polymer layer. In one subclass of this class, the second barrier coating comprises a UV curable coating. In one sub-subclass of this subclass, the UV curable coating for the second barrier coating is an acrylate coating.

In one subclass of this class, the first barrier coating and second barrier coating each comprises a UV curable coating. In a sub-subclass of this subclass, the UV curable coating for the first barrier coating and the second barrier coating are each an acrylate coating.

In one class of this embodiment, the interlayer further comprises a second polymer layer, and the HWP film has a second barrier coating on a second side in contact with the second polymer layer, and wherein the first barrier coating and the second barrier coatings each comprises a UV curable coating, wherein the UV curable coatings are each an acrylate coating.

In one embodiment, the interlayer further comprises an adhesion promoter. In one class of this embodiment, the adhesion promoter comprises a silane, an acrylate, a methacrylate, an acid, an acid scavenger (e.g., epoxide), or an epoxy compound. In one subclass of this class, the adhesion promoter comprises a silane compound. In one subclass of this class, the adhesion promoter comprises an acrylate compound. In one subclass of this class, the adhesion promoter comprises a methacrylate compound. In one subclass of this class, the adhesion promoter comprises an acid compound. In one subclass of this class, the adhesion promoter comprises an epoxy compound.

In one embodiment, the system is incorporated into an automobile.

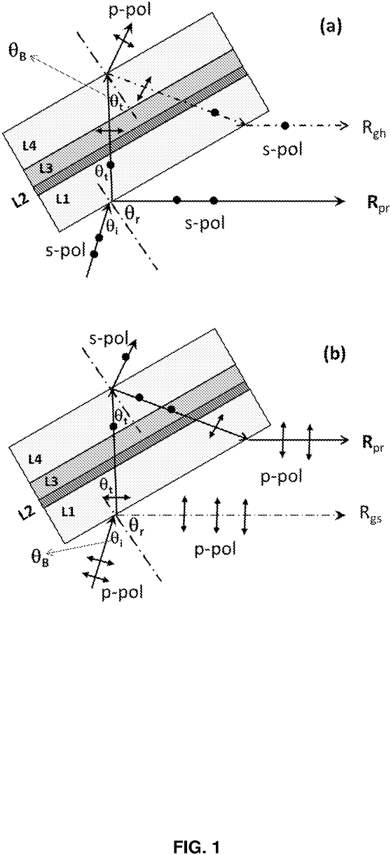

The concept of using a half wave plate (HWP) to eliminate or reduce the reflection of a ghost image in a heads-up display (HUD) has been disclosed in PCT No. 2017/223023. It disclosed that the windshield inner or outer surface can be used to reflect projected primary image combined with an HWP. The location of the HWP is between the two windshield glasses, where an interlayer also exists which is made from one or more polymer layers (e.g., polyvinylbutyryl polymer or a polyurethane polymer). The HWP could be located within the polymer layer, or between glass and the polymer layer as shown in FIGS. 1(a) and (b).

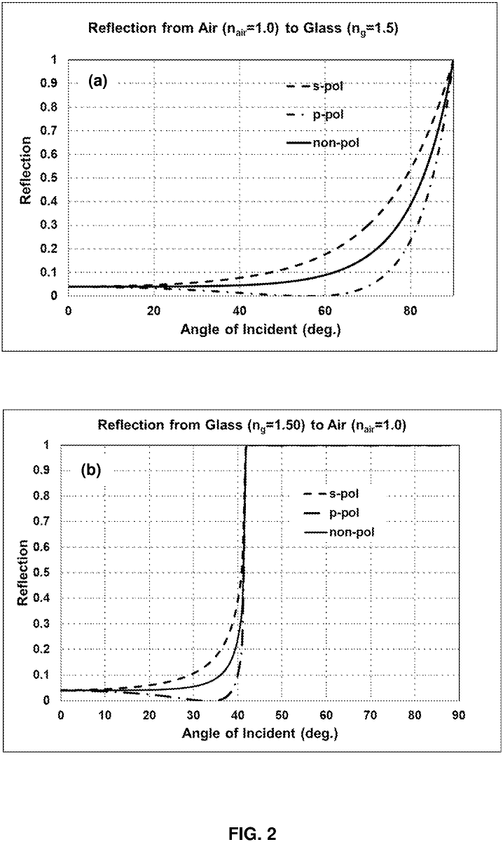

When using windshield inner surface to reflect primary image, as shown in FIG. 1(a), the incident light should have s-polarization (“s-pol”). Rₚᵣ is the intensity of primary reflective image, which has s-pol as well. But if a driver wearing polarizing sunglasses, he or she will not be able to see the HUD image. After s-pol incident light passes through the HWP L2, it changes to p-polarization (“p-pol”), which has low intensity of reflection, which corresponds to a ghost image R_{gh}, as shown in FIGS. 2(a) and 2(b). Especially when the incident angle close to Brewster angle, the ghost image intensity goes to zero.

Similarly, in FIG. 1(b), the incident light has p-pol. When the incident angle θᵢ is close to Brewster angle, the intensity of inner surface reflection is close to zero, and this corresponds to ghost image R_{gh} and has p-pol. After p-pol incident light passes through the HWP L2, it changes to s-pol. Therefore, the intensity of the outer surface reflection becomes primary image Rₚᵣ. Since Rₚᵣ passes through the HWP L2 again, it changes back to p-pol and the driver will be able to see the HUD image through a polarizing sunglasses.

For HUDs, high contrast ratio of Rₚᵣ/R_{gh} is always required. Therefore, we are seeking increase the intensity of Rₚᵣ and reduce the intensity of R_{gh} by optimizing the HUD optical system.

Therefore, in FIG. 1(a), in order to eliminate or minimize the ghost image R_{gh}, the complete conversion of s-pol to p-pol by the HWP is needed, which is the ideal case. In FIG. 1(b), in order to maximize the reflection of primary image Rₚᵣ, a complete conversion of p-pol to s-pol is required as well.

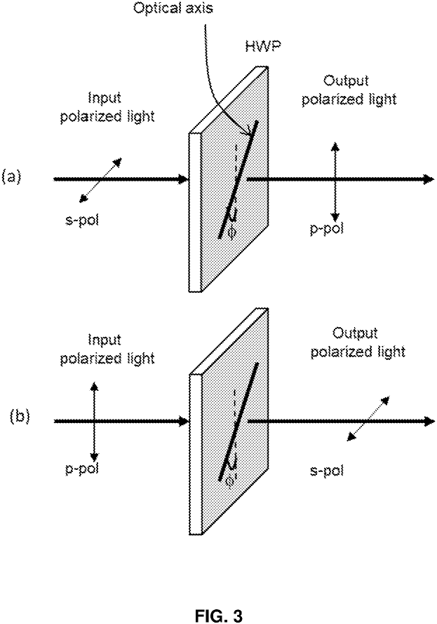

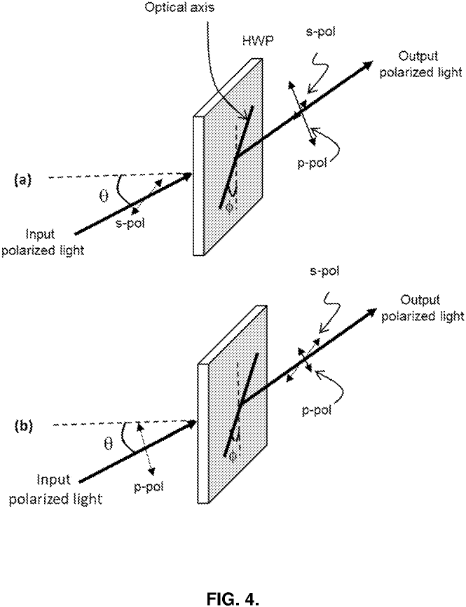

In general, complete converting projected input images from s-pol to p-pol or from p-pol to s-pol could only be realized by an HWP when the HWP optical axis angle Φ is 45° relative to p-pol direction at normal incident, as shown in FIGS. 3(a) and 3(b). However, in HUDs case, the incident light will never be at normal incident angle but at certain incident angle, as shown in FIGS. 4(a) and 4(b). When the incident angle is not equal to 90°, the HWP generally will not be able to do complete s-p/p-s polarization conversion because the HWP not only has in-plane retardation (Rₑ) of λ/2, but has out-of-plate retardation Rₜₕ, and the Rₜₕ of the HWP affect the conversion of s-p/p-s. The optical wave plate Rₑ and Rₜₕ are defined as:

$${\text{R}}_{\text{e}} \text{=} \left({\text{n}}_{\text{x}} {\text{-n}}_{\text{y}}\right) \text{*d} \qquad \text{Equation 1}$$

$${\text{R}}_{\text{th}} \text{=} \left[{\text{n}}_{\text{z}} \text{-} \left({\text{n}}_{\text{x}} {\text{+n}}_{\text{y}}\right) / 2\right] \text{*d} \qquad \text{Equation 2}$$

Usually polymer films are uniaxially or biaxially stretched to obtain non-zero Rₑ. Here nₓ is defined as the refractive index along larger stretch ratio direction in the HWP plane, n_{y} is defined as the refractive index along the direction orthogonal to the larger stretch ratio direction in the film plane, while n_{z} is defined as the refractive index normal to the HWP plane. For material with positive birefringence, we mean if the material is stretched along one direction (e.g. x direction), its refractive index along stretched direction (nₓ) is larger than that of orthogonal stretched direction (n_{y}), e.g. nₓ > n_{y} or Rₑ > 0. Here nₓ is defined as HWP slow axis and ny is its fast axis, and n_{z} is the refractive index along HWP surface normal direction. For material with negative birefringence, we mean if the material is stretched along one direction (e.g. x direction), its refractive index along stretched direction (nₓ) is smaller than that of orthogonal stretched direction (n_{y}), e.g. nₓ < n_{y} or Rₑ < 0. Here nₓ is defined as HPW fast axis and n_{y} is its slow axis, and n_{z} is the refractive index along HWP surface normal direction.

If a polymer film is angled stretched, the stretching direction may not be aligned with either fast axis or slow axis of the HWP:

For positive birefringent material,

$${\text{R}}_{\text{e}} \text{=} \left({\text{n}}_{\text{x}} {\text{-n}}_{\text{y}}\right) \text{*d} \qquad \text{Equation 3}$$

$${\text{R}}_{\text{th}} \text{=} \left[{\text{n}}_{\text{z}} \text{-} \left({\text{n}}_{\text{x}} {\text{+n}}_{\text{y}}\right) / 2\right] \text{*d} \qquad \text{Equation 4}$$

where nₓ is defined as the refractive index along slow axis in the HWP plane, n_{y} is defined as the refractive index along fast axis in the HWP plane, and n_{z} is defined as the refractive index normal to the HWP plane.

For negative birefringent material,

$${\text{R}}_{\text{e}} \text{=} \left({\text{n}}_{\text{x}} {\text{-n}}_{\text{y}}\right) \text{*d} \qquad \text{Equation 5}$$

$${\text{R}}_{\text{th}} \text{=} \left[{\text{n}}_{\text{z}} \text{-} \left({\text{n}}_{\text{x}} {\text{+n}}_{\text{y}}\right) / 2\right] \text{*d} \qquad \text{Equation 6}$$

where nₓ is defined as refractive index along fast axis in the HWP plane, n_{y} is defined as refractive index along slow axis in the HWP plane and n_{z} is defined as refractive index normal to the HWP.

At normal incident case, the incident polarized light only interacts with wave plate nₓ and n_{y}, which determines the wave plate in-plane retardation Rₑ =λ/2. While at oblique incident case, the incident polarization not only interacts with nₓ, n_{y}, but also with n_{z}. Therefore, if the wave plate Rₜₕ is not zero, the effective retardation of the HWP is no longer equal to λ/2 anymore. Therefore, the s-p/p-s polarization cannot be completely converted from one to the other. The output polarized light will contain small amount of input polarization as shown in FIGS. 4(a) and 4(b). Since the oblique incident polarized light causes s-pol to p-pol or p-pol to s-pol less than 100% conversion, this will result in decreased contrast ratio of Rₚᵣ/R_{gh}, therefore further optimizations of the optical system are needed when the HWP Rₜₕ is non-zero.

### Factor of Rₜₕ of an HWP

Based on optical simulations, the optimized optical axis angle Φ of HWP with respect to oblique incident angle θ at s- pol or p-pol can be determined to increase the contrast ratio of Rₚᵣ/R_{gh}, and the optimized angle Φ is dependent on the Rₜₕ of the HWP. The HWP orientation angle Φ is defined as the angle between the HWP optical axis and the projection of p-polarization direction of the incidence light onto the HWP plane, which mostly refers to windshield vertical direction. The optical axis of the HWP is along its nₓ direction. For films with positive Rₑ, the optical axis of the HWP is its slow axis. For films with negative Rₑ, the optical axis of the HWP is its fast axis. Therefore, during the lamination of glass-interlayer-HWP-interlayer-glass, the HWP lamination angle Φ needs to be considered depending on HWP Rₜₕ.

### Case 1: Rₑ= λ/2= 275 nm (λ~550 nm), Rₜₕ=0 nm, S-Pol Incident Light

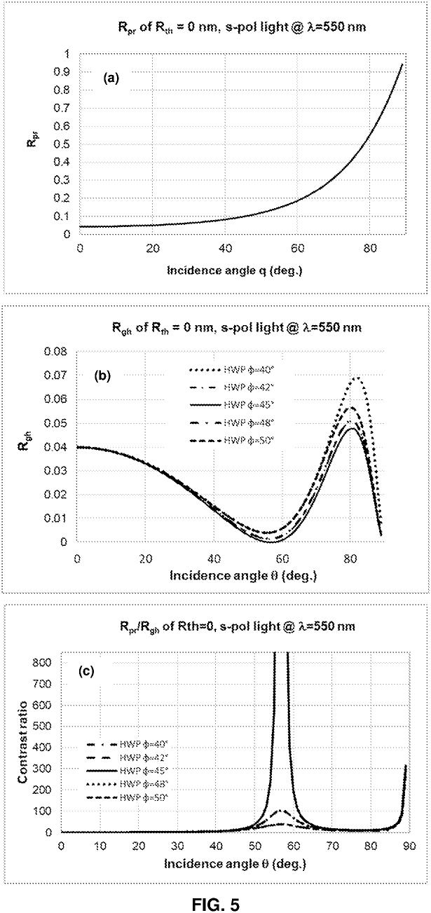

FIG. 5(a) plots the reflected primary image from the windshield inner surface, which is independent of the HWP optical properties. FIG. 5(b) plots the reflected ghost image R_{gh} from the windshield outer surface, which is a function of incident angle Θ and the HWP optical axis orientation Φ. FIG. 5(c) plots the contrast ratio of Rₚᵣ/R_{gh} as a function of the HWP optical axis angle Φ at different oblique incident angle Θ. These results illustrate when Rₑ=λ/2 and Rₜₕ=0, the optimized HWP optical axis angle Φ is still 45°, which gives best contrast ratio and is the same as normal incident case. However, an HWP with Rₜₕ=0 is extremely hard to obtain. This is a biaxially birefringent wave plate that refractive indices satisfy n_{z}=(nₓ+n_{y})/2, or N_{z} factor is equal to 0.5. Here N_{z} ₌(nₓ-n_{z})/(nₓ-n_{y}). Therefore, practical implement this type of HWP is almost impossible at foreseeable future. In addition, the optimal optical axis angle can be 135° in addition to 45°, which equals to 180° - Φ^{opt} and provide the same contrast ratios. Φ^{opt} is the optimal optical axis angle.

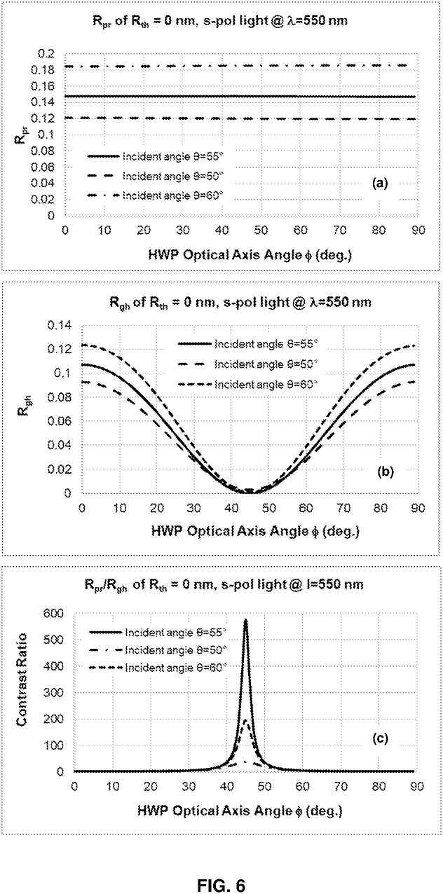

FIGS. 6(a), 6(b) and 6(c) are the same set of data of used in FIG. 5, but plotted Rₚᵣ,R_{gh} and Rₚᵣ/R_{gh} vs HWP optical axis Φ at different incident angle Θ. The results clearly illustrate that optimized the HWP optical axis angle Φ is at 45°, which has the lowest ghost image intensity R_{gh}, and highest contrast ratio Rₚᵣ/R_{gh} when incident angle Θ close to Brewster angle.

### Case 2: Rₑ=λ/2= 275 nm (λ~550 nm), Rₜₕ=-137 nm, S-Pol Incident Light

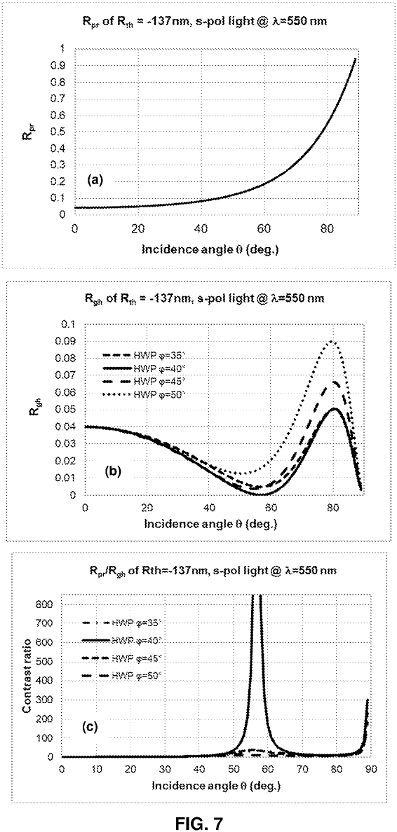

In general, an HWP’s Rₜₕ will not be zero. Here a special case of Rₑ=275 nm and Rₜₕ=-137 nm is considered. This HWP is uniaxially birefringent and its refractive indices satisfy nₓ>n_{y}=n_{z},, or N_{z}=1. FIG. 7(a) is the same as FIG. 5(a), the Rₚᵣ is the primary image reflected from the windshield inner surface and is independent of the HWP optical properties. FIGS. 7(b) and 7 (c) are like FIGS. 5(b) and 5(c). However, because the Rₜₕ is - 137 nm instead of 0 nm, the minimum ghost image R_{gh} appears at the HWP optical axis angle Φ=40° instead of 45°, and the maximum contrast ratio of Rₚᵣ/R_{gh} also appears at Φ=40° and incident angle Θ close to the Brewster angle, which is around 57°. In addition, the optimal optical axis angle can be 140° in addition to 40°, which equals to 180° - Φ^{opt} and provide the same contrast ratios. Φ^{opt} is the optimal optical axis angle.

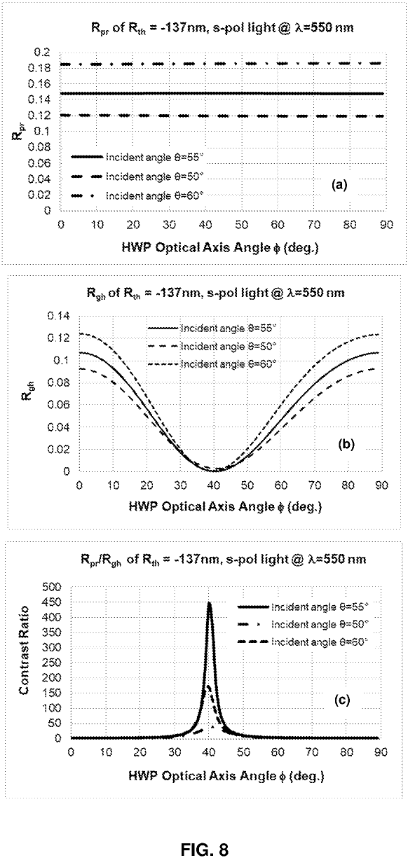

FIGS. 8(a), 8(b) and 8(c) are similar to FIGS. 6(a), 6(b) and 6(c), but for Rₜₕ=-137 nm instead of 0 nm. They clearly show that minimum ghost image R_{gh} is Φ=40° instead of 45°, which is the same for the contrast ratio plot of FIG. 8(c).

### Case 3: Rₑ=λ/2= 275 nm (λ~550 nm), Rₜₕ=-275 nm, S-Pol Incident Light

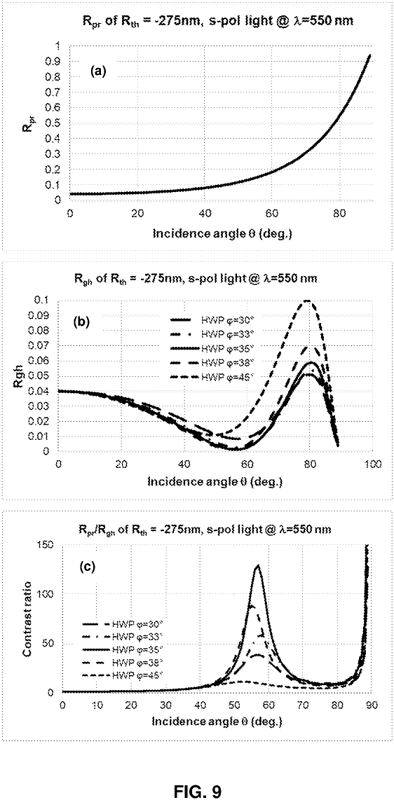

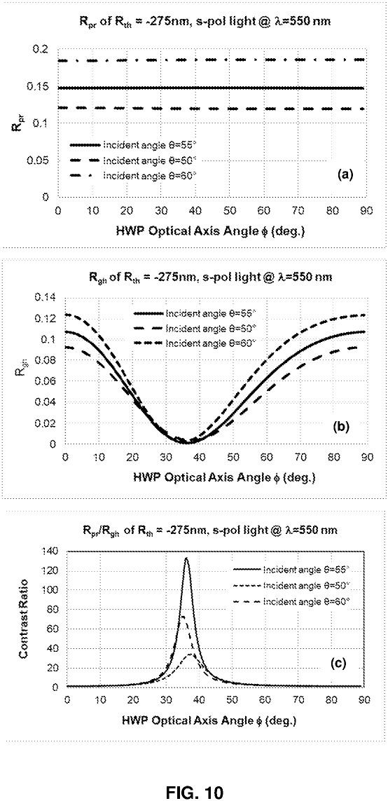

Doing similar simulation like case 1 and 2, when Rₜₕ equals to -275 nm, the simulation results are shown in FIGS. 9 and 10. The minimum ghost image of R_{gh} and contrast ratio of Rₚᵣ/R_{gh} are appeared when the HWP optical axis angle Φ=35°. In addition, the optimal optical axis angle can be 145° in addition to 35°, which equals to 180° - Φ^{opt} and provide the same contrast ratios. Φ^{opt} is the optimal optical axis angle.

From above special cases we conclude that the optimized HWP optical axis angle Φ depends on HWP out-of-plane retardation Rₜₕ, which corresponds to minimum ghost image R_{gh} and maximum contrast ratio of Rₚᵣ/R_{gh}. When Rₜₕ increases, the optical axis angle Φ moves to less than 45°.The higher the Rₜₕ, the smaller the Φ angle will be. Therefore, during the interlayer, such as PVB, and the HWP lamination, the optimized the HWP optical axis lamination angle Φ^{opt} respect to s-pol direction needs to be calculated based on the Rₜₕ of the HWP.

So far, the simulations are based on FIG. 1(a), where the incident light is s-pol. The same simulations are also performed for FIG. 1(b), where the incident light is p-pol. For p-pol incidence light, since R_{gh} from the front layer reflection is zero at Brewster angle, optimizing the HWP optical axis angle Φ^{opt} mainly enhances the reflection intensity at the out-surface. The optimized HWP optical axis angle Φ^{opt} for p-pol incidence light is the same as s-pol incidence light for the same HWP. Therefore, the simulation results are not shown here. The HWP optical axis angle mainly affect Rₚᵣ and Rₚᵣ/R_{gh} for p-pol incidence light.

In addition, in the discussion above, we only discussed HWP with positive Rₑ, i.e. nₓ > n_{y}. For HWP with negative Rₑ, i.e. nₓ < n_{y}, the optimized HWP optical axis follow the same trend. The HWP optical axis for negative Rₑ is defined as its fast axis (nₓ direction), while for positive Rₑ HWP, its optical axis is defined as slow axis. For HWP with Rₑ = -270 nm and Rₜₕ = 0 nm, the optimal optical axis angle Φ^{opt} of the HWP is 45° for incidence light at 550 nm. For HWP with Rₑ = -270 nm and Rₜₕ = 135 nm, the optimal optical axis angle Φ^{opt} is 40° for incidence light at 550 nm. For HWP with Rₑ = -270 nm and Rₜₕ = 270 nm, the optimal optical axis angle Φ^{opt} is 35° for incidence light at 550 nm.

### Effect of Wavelength Dispersion of Rₑ and Rₜₕ of the HWP

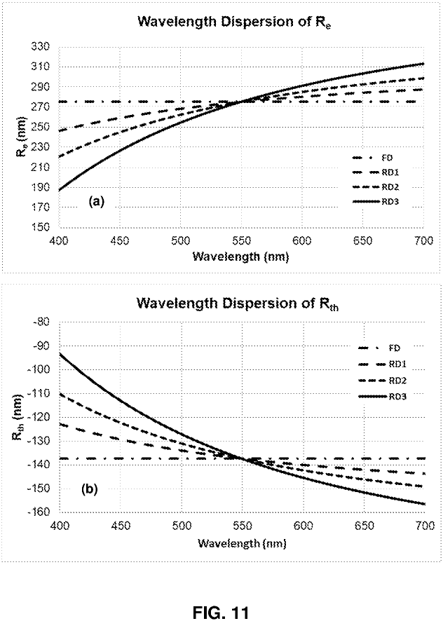

Besides the orientation angle Φ of the HWP laminated in the interlayer, such as PVB, its wavelength dispersion is another factor that can affect the intensity of ghost image R_{gh} and contrast ratio of Rₚᵣ/R_{gh} for s-pol incidence light, and can affect the intensity of primary image Rₚᵣ and contrast ratio of Rₚᵣ/R_{gh} for p-pol incidence light. Ideally the HWP is achromatic, which means the HWP in-plane retardation Re is λ/2 for all visible wavelength. However, in practice a broadband achromatic HWP is extremely hard to obtain. Therefore, an HWP with reverse wavelength dispersion or negative wavelength dispersion is preferred to flat and normal wavelength dispersion or positive wavelength dispersion. Reverse wavelength dispersion or negative wavelength dispersion means that as wavelength increases, Rₑ of the HWP also increases; and flat wavelength dispersion means that as wavelength increases, Rₑ of the HWP doesn’t change, while normal wavelength dispersion or positive wavelength dispersion means that as wavelength increases, Rₑ of the HWP decreases. FIGS. 11(a) and 11(b)show Rₑ and Rₜₕ of four different HWPs with different wavelength dispersion. Three of them have reverse dispersion (RD), and one of them has flat dispersion (FD). In flat panel display field, parameters of Rₑ(450)/Rₑ(550), Rₑ(650)/Rₑ(550), Rₜₕ(450)/Rₜₕ(550) and Rₜₕ(650)/Rₜₕ(550) of a waveplate are often used to describe its optical dispersion. The five HWP optical properties are listed in the Table 1 and Table 2, including for an ideal HWP and its dispersion. The dispersion of the HWP RD3 is closer to the ideal reverse optical dispersion.

TABLE 1

The optical retardation parameters of the hypothetical HWP films

| HWP | Re(550 nm) (nm) | Re(650 nm) (nm) | Rth(550 nm) (nm) | Rth(650 nm) (nm) |
|---|---|---|---|---|
| Ideal | 275 | 324.5 | 0 | 0 |
| FD | 275 | 275 | -137.5 | -137.5 |
| RD1 | 274.6 | 282.8 | -137.5 | -141.62 |
| RD2 | 275.1 | 291.61 | -137.5 | -145.75 |
| RD3 | 275.1 | 302.61 | -137.6 | -151.36 |

TABLE 2

The optical dispersion parameters of the hypothetical HWP films

| HWP | Re(450 nm)/Re(5 50 nm) (nm) | Re(650 nm)/Re(550 nm) (nm) | Rth(450 nm)/Rth( 550 nm) (nm) | Rth(650 nm)/R th(550 nm) (nm) |
|---|---|---|---|---|
| Ideal | 0.82 | 1.18 | 0.82 | 1.18 |
| FD | 1 | 1 | 1 | 1 |
| RD1 | 0.94 | 1.03 | 0.94 | 1.03 |
| RD2 | 0.89 | 1.06 | 0.89 | 1.06 |
| RD3 | 0.82 | 1.1 | 0.82 | 1.1 |

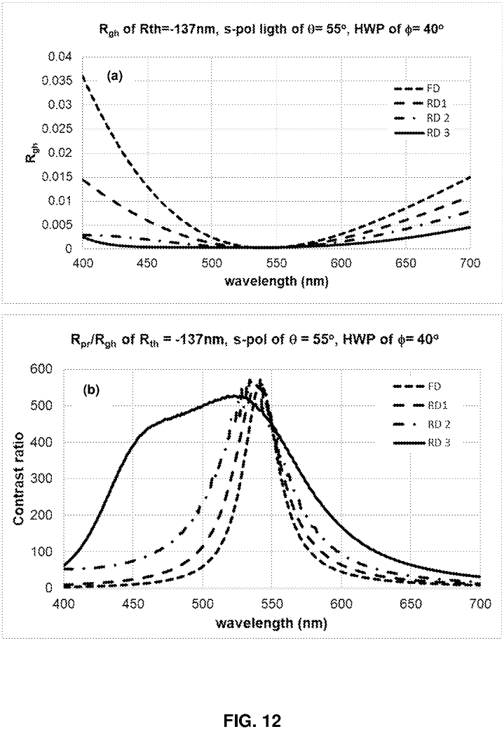

FIGS. 12(a) and 12(b) are optical simulation results of intensity of ghost image R_{gh} and contrast ratio Rₚᵣ/R_{gh} for above four different types of HWPs at incident angle Θ=55° and the HWP optical axis angle φ^{opt}=40°. Rₚᵣ used to calculate the contrast ratio is like previous section, which is independent of optical properties of the HWP for s-pol incidence light. The selection of Θ and Φ are based on the simulations performed in previous section case 2. The wavelength selected for these simulations covers visible wavelength range from 400 nm to 700 nm. These simulations illustrated that the HWP with reverse optical dispersion is better than flat dispersion or normal dispersion. The HWP with reverse dispersion properties close to ideal RD HWP performs the best from the point of view of minimizing reflection of ghost image R_{gh} and enhance the contrast ratio Rₚᵣ/R_{gh} for the broadband wavelength range. Therefore, the ranging performance from best to worst based on optical dispersion of these four HWPs is RD3>RD2>RD1 >FD.

### Effect of Input Polarization

PCT No. 2017/223023 has described in detail how the input polarization can affect HUDs application when an HWP is included in the interlayer, such as PVB lamination.

Currently using s-pol incident light is prevalently used in HUDs, which is shown in FIG. 1(a). Because it uses windshield inner surface to reflect HUDs primary image, the image quality is better due to the smoothness of the reflection surface. But the disadvantage is that the s-pol reflection image will be blocked by polarizing sunglasses.

For a driver wearing polarizing sunglasses, p-pol incident light is preferred as shown in FIG. 1(b), because p-pol images can pass through polarizing sunglasses. However, for p-pol incident light, the primary image is reflected from windshield outer surface, and light passes through the interlayer, such as PVB, and HWP twice. If the HWP is not perfectly flat, the reflected image quality might be degraded. Therefore, given a driver flexibility to change the incident light polarization from s-pol to p-pol or from p-pol to s-pol will be important. There are several ways to do this.

### 90° TN Liquid Crystal Device (TN-LCD)

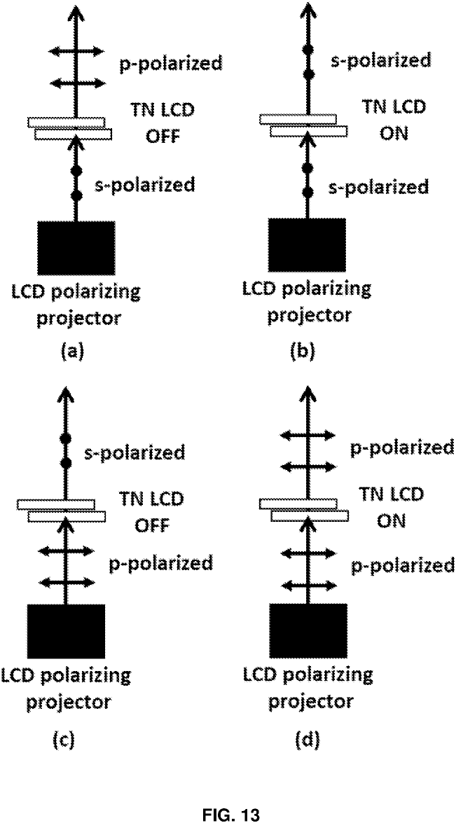

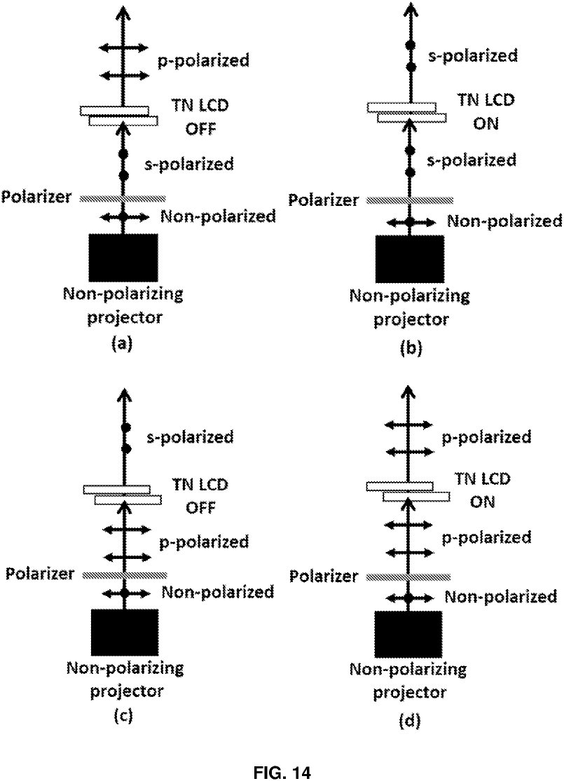

FIG. 13 illustrated using 90° twisted nematic liquid crystal device (TN-LCD) to realize the input polarization conversion from s-pol to p-pol or from p-pol to s-pol. Here assuming the projector output is linearly polarized light, such as Liquid crystal-based projector. When the TN-LCD is off (no voltage is applied), it will convert s-pol to s-pol or p-pol to s-pol as shown in FIGS. 13(a) and 13(c). When the TN-LCD is on (voltage is applied), the input polarization is the same as the output polarization as shown in FIGS. 13 (b) and 13(d). If the projector is non-polarizing-based, such as DLP projector, a linear polarizer can be used in front of the projector to generate s-polarizing or p-polarizing incident light as shown in FIG. 14.

### ECB Liquid Crystal Device (ECB-LCD) and VA Liquid Crystal Device (VA-LCD)

A liquid crystal cell with anti-parallel rubbed planar alignment layer provides an electrically controlled birefringence liquid crystal device (ECB-LCD). When the device is off and the in-plane retardation of this ECB-LCD is λ/2, it acts like HWP, which can convert polarization from s-pol to p-pol or p-pol to s-pol when the LC cell rubbing direction is at 45° with respect to either s-pol or p-pol direction. When the device is on, its retardation goes to zero. Therefore, the input and output polarization will be the same, which is very similar to TN-LCD.

A liquid crystal cell with anti-parallel rubbed vertical alignment layer provides a vertically aligned liquid crystal device (VA-LCD). When the device is off and the in-plane retardation of this device is zero, the input and output polarization will be the same. When the device is on, its in-plane retardation can achieve λ/2 and it acts like HWP. It can convert polarization from s-pol to p-pol or p-pol to s-pol when the LC cell rubbing direction is at 45° with respect to either s-pol or p-pol direction.

Therefore, besides TN-LCD, ECB-LCD and VA-LCD can also be used to electronically control the polarization rotation or s-pol and p-pol conversion. However, TN-LCD is still preferred, since if properly designed, it can convert a broadband visible wavelength at the same time.

### An HWP Waveplate

A half waveplate (HWP) can also be used to convert the input polarization from s-pol to p-pol, or p-pol to s-pol, just like it in the windshield of PVB-HWP-PVB lamination. The difference is that the HWP is in front of the projector, so the projector image is normal incident to the HWP. When the HWP optical axis is parallel or perpendicular to s-pol or p-pol, the input polarization will not change after passing through the HWP. When the HWP optical axis is oriented 45° with respect to the input s-pol or p-pol, the input polarization will change to 90°. Therefore, the input s-pol will change to p-pol, and the input p-pol will change to s-pol after passing through the HWP.

Mechanically rotate the HWP optical axis between 0° and 45° can select the polarization to be s-pol or p-pol.

In a windscreen, the optical film used to rotate or convert the polarization will often directly contact either the polymer layer or the glass, so it is necessary and desirable to make the optical film invisible. The optical film may be used in the entire windscreen, or it may only be present in a portion of the windscreen, such as in the windscreen only in front of the driver or on the driver’s side. Having a refractive index of the optical film that is equal or very similar to the refractive index of either the polymer layer material (such as PVB) or glass may be desirable for some applications, while in other applications, it is not necessary. Examples of materials that may be used for the optical film include, but are not limited to, cellulose ester optical films, such as cellulose triacetate (CTA), cellulose acetate propionate (CAP), cellulose acetate butyrate (CAB), and the like. In embodiments, the cellulose ester optical films may have a refractive index in the range of about 1.47 to 1.57. Other materials having an appropriate refractive index value as well as other necessary and desirable properties may be used as well, such as polycarbonates, co-polycarbonates, cyclic olefin polymers (“COP”), cyclic olefin copolymers (“COC”), polyesters, co-polyesters, and combinations of the foregoing polymers.

### Specific Embodiments

Embodiment 1: An interlayer, comprising:
(a) a first polymer layer; and
(b) a half waveplate (“HWP”) film comprising a polymeric material,
   wherein the HWP film has a plane and an optical axis, wherein the optical axis has an angle phi (Φ) relative to the axis formed from the p-polarization direction of a display light projected onto the plane of the HWP film,
   wherein Φ is from an angle of 30° to less than 45°, an angle of greater than 45° to 55°, an angle of greater than 135° to 150°, or an angle of 125° to less than 135°, and
   wherein the HWP film exhibits an in-plane retardation measured at 550 nm (“Rₑ[550 nm]”) of from -200 nm to -350 nm or from 200 nm to 350 nm, and an out-of-plane retardation measured at 550 nm (“Rₜₕ[550 nm]”) of from -350 nm to 350 nm.

Embodiment 2. The interlayer of embodiment 1, wherein the HWP film exhibits:
(1) an Rₑ[550 nm] that is from -220 nm to -325 nm or from 220 nm to 325 nm, and a Rₜₕ[550 nm] that is from -275 nm to 275 nm; or
(2) an Rₑ[550 nm] that is from -250 nm to -300 nm or from 250 nm to 300 nm, and a Rₜₕ[550 nm] that is from -150 nm to 150 nm.

Embodiment 3. The interlayer of any one of embodiments 1-2, wherein:
(1) the ratio of Rₜₕ[550 nm] to Rₑ[550 nm] for the HWP film is from -0.2 to 0.2, and wherein Φ is from 42° to less than 45°, greater than 45° to 52°, from greater than 135° to 138°, or from 128° to less than 135°;
(2) the ratio of Rₜₕ[550 nm] to Rₑ[550 nm] for the HWP film is from -1.2 to -0.8, and Φ is from 30° to 40° or from 140° to 150°;
(3) the ratio of Rₜₕ[550 nm] to Rₑ[550 nm] for the HWP film is from 0.8 to -0.2, and Φ is from 36° and 44° or from 136° to 144°; or
(4) the ratio of Rₜₕ[550 nm] to Rₑ[550 nm] for the HWP film is from -2.0 to -1.2, and Φ is from 30° to 38° or from 142° to 150°.

Embodiment 4. The interlayer system of any one of embodiments 1-3, wherein:
(1) the ratio of Rₑ[450 nm] to Rₑ[550 nm] for the HWP film is from 0.75 to 1.10, and the ratio of Rₑ[650 nm] to Rₑ[550 nm] for the HWP film is from 0.95 to 1.25;
(2) the ratio of Rₑ[450 nm] to Rₑ[550 nm] for the HWP film is from 0.80 to 1.0, and the ratio of Rₑ[650 nm] to Rₑ[550 nm] for the HWP film is from 1.0 to 1.25; or
(3) the ratio of Rₑ[450 nm] to Rₑ[550 nm] for the HWP film is from 0.82 to 0.90, and the ratio of Rₑ[650 nm] to Rₑ[550 nm] for the HWP film is from 1.05 to 1.18.

Embodiment 5. The interlayer of anyone of embodiments 1-4, wherein the HWP film is a multilayer film.

Embodiment 6. The interlayer of embodiment 5, wherein the multilayer film is a stack of two quarter wave plate films.

Embodiment 7. The interlayer of any one of embodiments 1-6, wherein the polymeric material comprises a cellulose ester, a polycarbonate, a co-polycarbonate, a cyclic olefin polymer, a cyclic olefin copolymer, a polyester, a co-polyester, a polymerized thermotropic liquid crystal, a dried lyotropic liquid crystal or combinations thereof.

Embodiment 8. The interlayer of embodiment 7, wherein the polymeric material is a cellulose ester.

Embodiment 9. The interlayer of embodiment 8, wherein the cellulose ester is a regioselectively substituted cellulose ester.

Embodiment 10. The interlayer of any one of embodiments 7-9, wherein the polymeric material further comprises a plasticizer composition.

Embodiment 11. The interlayer of any one of embodiments 1-10, wherein the first polymer layer comprises a first polymer composition comprising a poly(vinylacetal), a polyurethane, a poly(ethylene-co-vinyl)acetate, a polyvinyl chloride, a poly(vinylchloride-co-methacrylate), a polyethylene, a polyolefin, an ethylene acrylate ester copolymer, a poly(ethylene-co-butyl acrylate), a silicone elastomer, or an epoxy resin.

Embodiment 12. The interlayer of embodiment 11, wherein the first polymer composition comprises a poly(vinylacetal).

Embodiment 13. The interlayer of embodiment 12, wherein the poly(vinylacetal) is a poly(vinyl butyral).

Embodiment 14. The interlayer of embodiment 11, wherein the first polymer composition comprises a polyurethane.

Embodiment 15. The interlayer of any one of embodiments 10-14, wherein the first polymer composition further comprises a plasticizer composition.

Embodiment 16. The interlayer of any one of embodiments 1-15, wherein the interlayer further comprises a second polymer layer, wherein the HWP film is disposed between the first polymer layer and the second polymer layer.

Embodiment 17. The interlayer of embodiment 16, wherein the comprises a second polymer composition comprising a poly(vinylacetal), a polyurethane, a poly(ethylene-co-vinyl)acetate, a polyvinyl chloride, a poly(vinylchloride-co-methacrylate), a polyethylene, a polyolefin, an ethylene acrylate ester copolymer, a poly(ethylene-co-butyl acrylate), a silicone elastomer, or an epoxy resin.

Embodiment 18. The interlayer of embodiment 17, wherein the second polymer composition comprises a poly(vinylacetal).

Embodiment 19. The interlayer of embodiment 18, wherein the poly(vinylacetal) is a poly(vinyl butyral).

Embodiment 20. The interlayer of embodiment 17, wherein the second polymer composition comprises a polyurethane.

Embodiment 21. The interlayer of any one of embodiments 17-20, wherein the first polymer composition further comprises a plasticizer composition.

Embodiment 22. The interlayer of any one of embodiments 16-21, wherein at least one of the first polymer layer and the second polymer layer is a multilayer polymer.

Embodiment 23. The interlayer of any one of embodiments 15-22, wherein the HWP film has a first barrier coating on a first side in contact with the first polymer layer and a second barrier coating on a second side in contact with the second polymer layer.

Embodiment 24. The interlayer of embodiment 23, wherein the first barrier coating comprises a UV curable coating.

Embodiment 25. The interlayer of embodiment 24, wherein the UV curable coating for the first barrier coating is an acrylate coating.

Embodiment 27. The interlayer of any one of embodiments 23-26, wherein the second barrier coating comprises a UV curable coating.

Embodiment 28. The interlayer of embodiment 26, wherein the UV curable coating for the second barrier coating is an acrylate coating.

Embodiment 29. The interlayer of any one of embodiments 23-27, wherein the first barrier coating and the second barrier coating are the same.

Embodiment 30. The interlayer of any one of embodiments 1-29, further comprising an adhesion promoter.

Embodiment 31. A head-up display system, comprising:

an article comprising:
(i) a first rigid substrate having a first outer surface and a first normal axis
(ii) a second rigid substrate having a second outer surface; and
(iii) an interlayer of any one of embodiments 1-30, wherein the interlayer is disposed between the first rigid substrate and the second rigid substrate.

Embodiment 32. The system of embodiment 31, wherein the system exhibits a projected image in which the intensity ratio of the primary image to the secondary (ghost) image is greater than 50.

Embodiment 33. The system of any one of embodiments 31-32, wherein the article further comprises an adhesion promoter.

Embodiment 34. The system of any one of embodiments 31-33, further comprising (2) a display device for generating the display light as polarized light, and wherein the display light comprises information.

Embodiment 35. The system of any one of embodiments 31-33, further comprising (2) a display device for generating the display light, wherein the display light comprises information; and (3) a light polarizing device for polarizing the display light.

Embodiment 36. The system of any one of embodiments 34 or 35, further comprising a polarization rotator, which is an active polarization rotator or a passive polarization rotator.

Embodiment 37. The system of embodiment 36, wherein the passive polarization rotator is a HWP film.

Embodiment 38. The system of embodiment 36, wherein the polarization rotator is an active polarization rotator.

Embodiment 39. The system of embodiment 38, wherein the active polarization rotator is (i) an active twisted nematic liquid crystal device (“TN-LCD”), (ii) an active electrically controlled birefringence liquid crystal device (“ECB-LCD”), or (iii) an active vertically aligned liquid crystal device (“VA-LCD”).

Embodiment 40. The system of any one of embodiments 34-39, wherein the display light is projected incident on the first outer surface at an angle of incidence (Θ) relative to the first normal axis, wherein Θ is from 45° to 70°.

### Experimental Results

### Abbreviations

HWP is half waveplate; COP is cyclic olefin polymer; nm is nanometer; mm is millimeter; Rₜₕ is out-of-plane retardation; Rₑ is in-plane retardation; ° is degree; °C is degree(s) Celsius; min is minute(s); nm is nanometer(s); rt is room temperature; LED is light emitting diode; QWP is quarter waveplate; HWP is half waveplate; MeOH is methanol; DCM is dichloromethane; TD is transverse direction; MD is machine direction;

### General Procedure for Preparation of Laminates

The interlayers described herein can be laminated between glass using techniques known in the art. The typical glass lamination process comprises the following steps: (1) assembly of the two substrates (e.g., glass) and interlayer; (2) heating the assembly via an IR radiant or convective means for a short period; (3) passing the assembly into a pressure nip roll for the first deairing; (4) heating the assembly a second time to an appropriate temperature, such as about 50° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at an appropriate temperature and pressure, such as temperatures between 80 and 150° C. and pressures between 15 psig (1.0 barg) and 200 psig (13.8 barg) for about 30 to 90 min. Other means for use in de-airing of the interlayer-glass interfaces (steps 2 to 5) known in the art and that are commercially practiced include vacuum bag and vacuum ring processes in which a vacuum is utilized to remove the air. An alternate lamination process involves the use of a vacuum laminator that first de-airs the assembly and subsequently finishes the laminate at a sufficiently high temperature and vacuum.

Laminates 1-6 were assembled by stacking glass, interlayer, HWP film, interlayer, and glass, de-aired using a standard vacuum bag de-airing technique, and finished using a standard autoclave process. During assembly, the HWP film was laminated such that the optical axis was aligned parallel with the vertical edges of the glass. After assembly, each laminate was de-aired in a vacuum bag under vacuum for 20 min at rt followed by 30 min at 105° C. to provide intermediate bonding and interlayer flow and to seal the laminate edges in preparation for autoclave processing. Laminates 1 & 2 were autoclaved using conditions of a 20-min hold at 125° C. and 13 bar due to the limited heat stability of the COP HWP films, while Laminates 3-6 were autoclaved using standard conditions of a 20-min hold at 143° C. and 13 bar.

In order to measure the contrast ratio of test images projected onto the laminates, a test rig was built that utilizes a consumer LED pico-projector producing a solid color image approximately 3 mm × 100 mm that passes through a polarizing film oriented to allow only s-polarized light to pass, and is projected incident onto the laminate’s surface at 56.5° from normal. The laminate is positioned such that it can be rotated to orient the optical axis of the HWP film throughout a full 360° rotation. The resulting image reflected off of the laminate is captured by a machine vision camera and lens focused on the virtual image of the original 3 mm × 100 mm real image. White solid images are all captured in this manner and subsequently analyzed to determine the contrast ratio of the intensities of the primary to secondary image.

Image analysis can be conducted using Origin Pro, or any similar software package that can convert a digital image file to a matrix of pixel intensities for subsequent analysis. The contrast ratios between the primary and secondary images were measured using the following equation

$$C R = \frac{{I}_{p} - {I}_{b}}{{I}_{s} - {I}_{b}}$$

Where Iₚ is the average intensity of the primary image, Iₛ is the average intensity of the secondary image, and I_{b} is the background intensity.

Laminate 1 and laminate 2 were made from Film 1 and Film 2. Film 1 and Film 2 were achieved by stacking two layers of Zeonor ZM16-138 QWP Film, which is made from a cyclo-olefin polymer, COP, obtained from Zeon Corporation. An acrylic pressure sensitive adhesive was used to stack the two layers. Optical properties of Film 1: thickness= 176 µm; Re(589 nm)=275.8 nm; Rth(589 nm)=-142.5 nm; and Film 2: thickness= 176 µm; Re(589 nm)=275.8 nm; Rth(589 nm)=-143.7 nm.

Laminates 3-6 were made using Film 3-6 which were prepared from a cast dope (12-20 wt% cellulose ester in DCM:MeOH (87:13)) cellulose acetate propionate (Ex 18, US20090096962) to provide an unstretched film having a 80 µm thickness, Rₑ (589 nm)=~1 nm, Rₜₕ(589 nm)=-240 nm. The resulting films could be plasticized or unplasticized. The final films were stretched as follows:
(1) Film 3: stretched at 175° C. from 148 mm to 207 mm along the MD and shrunk from 218 mm to 175 mm along the TD (Optical Properties: film thickness=70 µm, Rₑ(589 nm)=276.0 nm, Rₜₕ(589 nm)=-228 nm);
(2) Film 4: stretched 175° C. from 190 mm to 266 mm along the MD and shrunk from 205 mm to 165 mm along the TD (Optical Properties: film thickness=70 µm, Rₑ(589 nm)=331.0 nm, Rₜₕ(589 nm)=-248.0 nm);
(3) Film 5: stretched at 175° C. from 240 mm to 336 mm along the MD and shrunk from 185 mm to 145 mm along the TD (Optical Properties: film thickness=6 µm, Rₑ(589 nm)=295.0 nm, Rₜₕ(589 nm)=-239.0 nm);
(4) Film 6: stretched at 175° C. from 238 mm to 328 mm along the MD and shrunk from 238 mm to 190 mm along the TD (Optical Properties: film thickness=76 µm, Rₑ(589 nm)=318.0 nm, Rₜₕ(589 nm)=-236.0 nm).
The optical properties of the laminates made from these films may change after the lamination process with PVB and glass.

Laminate 1

(HWP Film: Film 1)
Slow Axis Angle (°)

| | | | | |
|---|---|---|---|---|
| | 45 | 42 | 40 | 37 |
| White Light Contrast Ratio (Rₚᵣ/R_{gh}) | 59 | 84 | 75 | 41 |

Laminate 2

(HWP Film: Film 2)
Slow Axis Angle (°)

| | | | | |
|---|---|---|---|---|
| | 45 | 42 | 40 | 37 |
| White Light Contrast Ratio (Rₚᵣ/R_{gh}) | 41 | 69 | 75 | 45 |

Laminate 3

(HWP Film: Film 3)
Slow Axis Angle (°)

| | | | | |
|---|---|---|---|---|
| | 45 | 42 | 40 | 37 |
| White Light Contrast Ratio (Rₚᵣ/R_{gh}) | 21 | 39 | 35 | 23 |

Laminate 4

(HWP Film: Film 4)
Slow Axis Angle (°)

| | | | | |
|---|---|---|---|---|
| | 45 | 42 | 40 | 37 |
| White Light Contrast Ratio (Rₚᵣ/R_{gh}) | 24 | 95 | 61 | 24 |

Laminate 5

(HWP Film: Film 5)
Slow Axis Angle (°)

| | | | | |
|---|---|---|---|---|
| | 45 | 42 | 40 | 37 |
| White Light Contrast Ratio (Rₚᵣ/R_{gh}) | 29 | 80 | 64 | 27 |

Laminate 6

(HWP Film: Film 6)
Slow Axis Angle (°)

| | | | | |
|---|---|---|---|---|
| | 45 | 42 | 40 | 37 |
| White Light Contrast Ratio (Rₚᵣ/R_{gh}) | 27 | 71 | 34 | 14 |

What is claimed is:

1. An interlayer, comprising:
(a) a first polymer layer; and
(b) a half waveplate (“HWP”) film comprising a polymeric material,
wherein the HWP film has a plane and an optical axis, wherein the optical axis has an angle phi (ϕ) relative to the axis formed from the p-polarization direction of a display light projected onto the plane of the HWP film,
wherein Φ is from an angle of 30° to less than 45°, an angle of greater than 45° to 55°, an angle of greater than 135° to 150°, or an angle of 125° to less than 135°, and
wherein the HWP film exhibits an in-plane retardation measured at 550 nm (“Rₑ[550 nm]”) of from -200 nm to -350 nm or from 200 nm to 350 nm, and an out-of-plane retardation measured at 550 nm (“Rₜₕ[550 nm]”) of from -350 nm to 350 nm.

2. The interlayer of claim 1, wherein the HWP film exhibits:
(1) an Rₑ[550 nm] that is from -220 nm to -325 nm or from 220 nm to 325 nm, and a Rₜₕ[550 nm] that is from -275 nm to 275 nm; or
(2) an Rₑ[550 nm] that is from -250 nm to -300 nm or from 250 nm to 300 nm, and a Rₜₕ[550 nm] that is from -150 nm to 150 nm.

3. The interlayer of claim 1, wherein:
(1) the ratio of Rₜₕ[550 nm] to Rₑ[550 nm] for the HWP film is from -0.2 to 0.2, and wherein ϕ is from 42° to less than 45°, greater than 45° to 52°, from greater than 135° to 138°, or from 128° to less than 135°;
(2) the ratio of Rₜₕ[550 nm] to Rₑ[550 nm] for the HWP film is from -1.2 to -0.8, and ϕ is from 30° to 40° or from 140° to 150°;
(3) the ratio of Rₜₕ[550 nm] to Rₑ[550 nm] for the HWP film is from 0.8 to -0.2, and ϕ is from 36° and 44°or from 136° to 144°; or
(4) the ratio of Rₜₕ[550 nm] to Rₑ[550 nm] for the HWP film is from -2.0 to -1.2, and ϕ is from 30° to 38° or from 142° to 150°.

4. The interlayer system of claim 1, wherein:
(1) the ratio of Rₑ[450 nm] to Rₑ[550 nm] for the HWP film is from 0.75 to 1.10, and the ratio of Rₑ[650 nm] to Rₑ[550 nm] for the HWP film is from 0.95 to 1.25;
(2) the ratio of Rₑ[450 nm] to Rₑ[550 nm] for the HWP film is from 0.80 to 1.0, and the ratio of Rₑ[650 nm] to Rₑ[550 nm] for the HWP film is from 1.0 to 1.25; or
(3) the ratio of Rₑ[450 nm] to Rₑ[550 nm] for the HWP film is from 0.82 to 0.90, and the ratio of Rₑ[650 nm] to Rₑ[550 nm] for the HWP film is from 1.05 to 1.18.

5. The interlayer of claim 1, wherein the HWP film is a multilayer film that is a stack of two quarter wave plate films.

6. The interlayer of claim 1, wherein the polymeric material comprises a cellulose ester.

7. The interlayer of claim 6, wherein the cellulose ester is a regioselectively substituted cellulose ester.

8. The interlayer of claim 1, wherein the first polymer layer comprises poly(vinyl butyral).

9. The interlayer of claim 1, wherein the interlayer further comprises a second polymer layer, wherein the HWP film is disposed between the first polymer layer and the second polymer layer.

10. The interlayer of claim 9, wherein the second polymer layer comprises a second polymer composition comprising a poly(vinylacetal), a polyurethane, a poly(ethylene-co-vinyl)acetate, a polyvinyl chloride, a poly(vinylchloride-co-methacrylate), a polyethylene, a polyolefin, an ethylene acrylate ester copolymer, a poly(ethylene-co-butyl acrylate), a silicone elastomer, or an epoxy resin.

11. The interlayer of claim 9, wherein the HWP film has a first barrier coating on a first side in contact with the first polymer layer and a second barrier coating on a second side in contact with the second polymer layer.

12. The interlayer of claim 1, further comprising an adhesion promoter.

13. A head-up display system, comprising:
(1) an article comprising:
(i) a first rigid substrate having a first outer surface and a first normal axis
(ii) a second rigid substrate having a second outer surface; and
(iii) the interlayer of claim 1, wherein the interlayer is disposed between the first rigid substrate and the second rigid substrate.

14. The system of claim 13, wherein the system exhibits a projected image in which the intensity ratio of the primary image to the secondary (ghost) image is greater than 50.

15. The system of claim 13, wherein the article further comprises an adhesion promoter.

16. The system of claim 13, further comprising (2) a display device for generating the display light as polarized light, and wherein the display light comprises information.

17. The system of claim 13, further comprising (2) a display device for generating the display light, wherein the display light comprises information; and (3) a light polarizing device for polarizing the display light.

18. The system of claim 17, further comprising a polarization rotator, which is an active polarization rotator or a passive polarization rotator.

19. The system of claim 18, wherein the passive polarization rotator is a HWP film.

20. The system of claim 18, wherein the polarization rotator is an active polarization rotator.

21. The system of claim 20, wherein the active polarization rotator is (i) an active twisted nematic liquid crystal device (“TN-LCD”), (ii) an active electrically controlled birefringence liquid crystal device (“ECB-LCD”), or (iii) an active vertically aligned liquid crystal device (“VA-LCD”).

22. The system of claim 20, wherein the display light is projected incident on the first outer surface at an angle of incidence Ѳ relative to the first normal axis, wherein Ѳ is from 45° to 70°.
